(19) United States
(12) Patent Application Publication
(10) Pub. No.: US 2026/0128830 A1
(43) Pub. Date: May 7, 2026

(54) SECURITY ENHANCEMENTS ON TRACKING REFERENCE SIGNAL (TRS) FOR POSITIONING AND SENSING OPERATIONS

(71) Applicant: QUALCOMM Incorporated, San Diego, CA (US)

(72) Inventors: Weimin DUAN, San Diego, CA (US); Jing LEI, San Diego, CA (US); Kangqi LIU, San Diego, CA (US)

(21) Appl. No.: 18/936,530

(22) Filed: Nov. 4, 2024

(51) Int. Cl. H04L 5/00

(52) U.S. Cl. CPC H04L 5/0048

(57) ABSTRACT

Disclosed are techniques for wireless sensing. In some aspects, a user equipment (UE) may receive, from a network node, one or more tracking reference signal (TRS) resource configurations of a plurality of TRS resource configurations for a plurality of TRS resources, wherein each of the plurality of TRS resource configurations configures one or more TRS resources to avoid one or more security attack types of a plurality of security attack types. The UE may perform one or more sensing operations, one or more positioning operations, or any combination thereof, based on the one or more TRS resource configurations.

### TECHNICAL FIELD

Aspects of the disclosure relate generally to wireless technologies.

### BACKGROUND

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service and a fourth-generation (4G) service (e.g., Long Term Evolution (LTE) or WiMax). There are presently many different types of wireless communication systems in use, including cellular and personal communications service (PCS) systems. Examples of known cellular systems include the cellular analog advanced mobile phone system (AMPS), and digital cellular systems based on code division multiple access (CDMA), frequency division multiple access (FDMA), time division multiple access (TDMA), the Global System for Mobile communications (GSM), etc.

A fifth generation (5G) wireless standard, referred to as New Radio (NR), enables higher data transfer speeds, greater numbers of connections, and better coverage, among other improvements. The 5G standard, according to the Next Generation Mobile Networks Alliance, is designed to provide higher data rates as compared to previous standards, more accurate positioning (e.g., based on reference signals for positioning (RS-P), such as downlink, uplink, or sidelink positioning reference signals (PRS)), RF sensing, and other technical enhancements. These enhancements, as well as the use of higher frequency bands, enable improved RF sensing and 5G-based positioning.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In some aspects, a method of wireless communication at a user equipment (UE) includes receiving, from a network node, one or more tracking reference signal (TRS) resource configurations of a plurality of TRS resource configurations for a plurality of TRS resources, wherein each of the plurality of TRS resource configurations configures one or more TRS resources to avoid one or more security attack types of a plurality of security attack types; and performing one or more sensing operations, one or more positioning operations, or any combination thereof, based on the one or more TRS resource configurations.

In some aspects, a method of wireless communication at a network node includes determining, for a user equipment (UE), one or more tracking reference signal (TRS) resource configurations of a plurality of TRS resource configurations for a plurality of TRS resources, wherein each of the plurality of TRS resource configurations configures one or more TRS resources to avoid one or more security attack types of a plurality of security attack types; and transmitting, to the UE, the one or more TRS resource configurations.

In some aspects, a user equipment (UE) includes one or more memories; one or more transceivers; and one or more processors communicatively coupled to the one or more memories and the one or more transceivers, the one or more processors, either alone or in combination, configured to: receive, via the one or more transceivers, from a network node, one or more tracking reference signal (TRS) resource configurations of a plurality of TRS resource configurations for a plurality of TRS resources, wherein each of the plurality of TRS resource configurations configures one or more TRS resources to avoid one or more security attack types of a plurality of security attack types; and perform one or more sensing operations, one or more positioning operations, or any combination thereof, based on the one or more TRS resource configurations.

In some aspects, a network node includes one or more memories; one or more transceivers; and one or more processors communicatively coupled to the one or more memories and the one or more transceivers, the one or more processors, either alone or in combination, configured to: determine, for a user equipment (UE), one or more tracking reference signal (TRS) resource configurations of a plurality of TRS resource configurations for a plurality of TRS resources, wherein each of the plurality of TRS resource configurations configures one or more TRS resources to avoid one or more security attack types of a plurality of security attack types; and transmit, via the one or more transceivers, to the UE, the one or more TRS resource configurations.

In some aspects, a user equipment (UE) includes means for receiving, from a network node, one or more tracking reference signal (TRS) resource configurations of a plurality of TRS resource configurations for a plurality of TRS resources, wherein each of the plurality of TRS resource configurations configures one or more TRS resources to avoid one or more security attack types of a plurality of security attack types; and means for performing one or more sensing operations, one or more positioning operations, or any combination thereof, based on the one or more TRS resource configurations.

In some aspects, a network node includes means for determining, for a user equipment (UE), one or more tracking reference signal (TRS) resource configurations of a plurality of TRS resource configurations for a plurality of TRS resources, wherein each of the plurality of TRS resource configurations configures one or more TRS resources to avoid one or more security attack types of a plurality of security attack types; and means for transmitting, to the UE, the one or more TRS resource configurations.

In some aspects, a non-transitory computer-readable medium stores computer-executable instructions that, when executed by a user equipment (UE), cause the UE to: receive, from a network node, one or more tracking reference signal (TRS) resource configurations of a plurality of TRS resource configurations for a plurality of TRS resources, wherein each of the plurality of TRS resource configurations configures one or more TRS resources to avoid one or more security attack types of a plurality of security attack types; and perform one or more sensing operations, one or more positioning operations, or any combination thereof, based on the one or more TRS resource configurations.

In some aspects, a non-transitory computer-readable medium stores computer-executable instructions that, when executed by a network node, cause the network node to: determine, for a user equipment (UE), one or more tracking reference signal (TRS) resource configurations of a plurality of TRS resource configurations for a plurality of TRS resources, wherein each of the plurality of TRS resource configurations configures one or more TRS resources to avoid one or more security attack types of a plurality of security attack types; and transmit, to the UE, the one or more TRS resource configurations.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communications system, according to aspects of the disclosure.

FIGS. 2A, 2B, and 2C illustrate example wireless network structures, according to aspects of the disclosure.

FIGS. 3A, 3B, and 3C are simplified block diagrams of several sample aspects of components that may be employed in a user equipment (UE), a base station, and a network entity, respectively, and configured to support communications as taught herein.

FIG. 4 is a diagram illustrating an example frame structure, according to aspects of the disclosure.

FIG. 5 is a diagram illustrating an example tracking reference signal (TRS) configuration, according to aspects of the disclosure.

FIG. 6 is a graph of an example channel energy response (CER) estimate, according to aspects of the disclosure.

FIG. 7 illustrates an example over-the-top (OTT)-based positioning procedure using TRS, according to aspects of the disclosure.

FIGS. 8A and 8B illustrate two types of man-in-the-middle attacks in which an attacker observes the first part of a positioning reference signal (PRS) and transmits during a second part of the PRS, according to aspects of the disclosure.

FIG. 9 illustrates an example diagram of partitioning of TRS blocks in a frequency domain and a time domain, according to aspects of the disclosure.

FIG. 10 illustrates an example of preventing a cyclic prefix (CP) attack, according to aspects of the disclosure.

FIGS. 11A and 11B illustrate example diagrams of TRS buffering period and TRS buffering number, respectively, according to aspects of the disclosure.

FIG. 12 illustrates an example method of wireless sensing, according to aspects of the disclosure.

FIG. 13 illustrates an example method of wireless sensing, according to aspects of the disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

Various aspects relate generally to wireless sensing. Some aspects more specifically relate to prevention of man-in-the-middle attacks in wireless sensing. In some examples, a user equipment (UE) may receive, from a network node, one or more tracking reference signal (TRS) resource configurations of a plurality of TRS resource configurations based on one or more security attack types of a plurality of security attack types, and perform one or more sensing operations based on the one or more TRS resource configurations.

Particular aspects of the subject matter described in this disclosure can be implemented to realize one or more of the following potential advantages. In some examples, by implementing one or more types of TRS resource configurations, including, for example, generating a TRS sequence with distinct and uncorrelated scrambling identifiers (IDs), the described techniques can be used to avoid various types of man-in-the-middle attacks.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE) and “base station” are not intended to be specific or otherwise limited to any particular radio access technology (RAT), unless otherwise noted. In general, a UE may be any wireless communication device (e.g., a mobile phone, router, tablet computer, laptop computer, consumer asset locating device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on the Institute of Electrical and Electronics Engineers (IEEE) 802.11 specification, etc.) and so on.

A base station may operate according to one of several RATs in communication with UEs depending on the network in which it is deployed, and may be alternatively referred to as an access point (AP), a network node, a NodeB, an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an uplink/reverse or downlink/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell (or several cell sectors) of the base station. Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals the UE is measuring. Because a TRP is the point from which a base station transmits and receives wireless signals, as used herein, references to transmission from or reception at a base station are to be understood as referring to a particular TRP of the base station.

In some implementations that support positioning of UEs, a base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

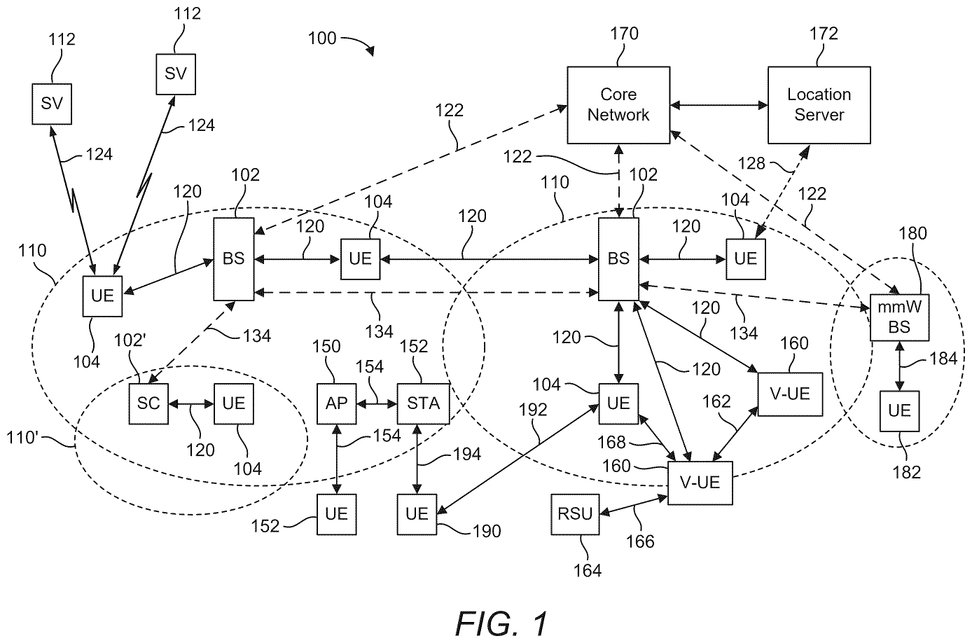

FIG. 1 illustrates an example wireless communications system 100, according to aspects of the disclosure. The wireless communications system 100 (which may also be referred to as a wireless wide area network (WWAN)) may include various base stations 102 (labelled “BS”) and various UEs 104. The base stations 102 may include macro cell base stations (high power cellular base stations) and/or small cell base stations (low power cellular base stations). In some aspects, the macro cell base stations 102 may include eNBs and/or ng-eNBs where the wireless communications system 100 corresponds to an LTE network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or 5G core (5GC)) through backhaul links 122, and through the core network 170 to one or more location servers 172 (e.g., a location management function (LMF) or a secure user plane location (SUPL) location platform (SLP)). The location server(s) 172 may be part of core network 170 or may be external to core network 170. A location server 172 may be integrated with a base station 102. A UE 104 may communicate with a location server 172 directly or indirectly. For example, a UE 104 may communicate with a location server 172 via the base station 102 that is currently serving that UE 104. A UE 104 may also communicate with a location server 172 through another path, such as via an application server (not shown), via another network, such as via a wireless local area network (WLAN) access point (AP) (e.g., AP 150 described below), and so on. For signaling purposes, communication between a UE 104 and a location server 172 may be represented as an indirect connection (e.g., through the core network 170, etc.) or a direct connection (e.g., as shown via direct connection 128), with the intervening nodes (if any) omitted from a signaling diagram for clarity.

In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/5GC) over backhaul links 134, which may be wired or wireless.

The base stations 102 may wirelessly communicate with the UEs 104. Each of the base stations 102 may provide communication coverage for a respective geographic coverage area 110. In some aspects, one or more cells may be supported by a base station 102 in each geographic coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), an enhanced cell identifier (ECI), a virtual cell identifier (VCI), a cell global identifier (CGI), etc.) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both the logical communication entity and the base station that supports it, depending on the context. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ (labelled “SC” for “small cell”) may have a geographic coverage area 110′ that substantially overlaps with the geographic coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a wireless local area network (WLAN) access point (AP) 150 in communication with WLAN stations (STAs) 152 via communication links 154 in an unlicensed frequency spectrum (e.g., 5 GHZ). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MULTEFIRE®.

The wireless communications system 100 may further include a mmW base station 180 that may operate in millimeter wave (mmW) frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHZ with a wavelength of 100 millimeters. The super high frequency (SHF) band extends between 3 GHz and 30 GHz, also referred to as centimeter wave. Communications using the mmW/near mmW radio frequency band have high path loss and a relatively short range. The mmW base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

Transmit beams may be quasi-co-located, meaning that they appear to the receiver (e.g., a UE) as having the same parameters, regardless of whether or not the transmitting antennas of the network node themselves are physically co-located. In NR, there are four types of quasi-co-location (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

Transmit and receive beams may be spatially related. A spatial relation means that parameters for a second beam (e.g., a transmit or receive beam) for a second reference signal can be derived from information about a first beam (e.g., a receive beam or a transmit beam) for a first reference signal. For example, a UE may use a particular receive beam to receive a reference downlink reference signal (e.g., synchronization signal block (SSB)) from a base station. The UE can then form a transmit beam for sending an uplink reference signal (e.g., sounding reference signal (SRS)) to that base station based on the parameters of the receive beam.

Note that a “downlink” beam may be either a transmit beam or a receive beam, depending on the entity forming it. For example, if a base station is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a base station is forming the uplink beam, it is an uplink receive beam, and if a UE is forming the uplink beam, it is an uplink transmit beam.

The electromagnetic spectrum is often subdivided, based on frequency/wavelength, into various classes, bands, channels, etc. In 5G NR two initial operating bands have been identified as frequency range designations FR1 (410 MHz-7.125 GHZ) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the INTERNATIONAL TELECOMMUNICATION UNION® as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHZ-114.25 GHZ), and FR5 (114.25 GHZ-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

In the example of FIG. 1, any of the illustrated UEs (shown in FIG. 1 as a single UE 104 for simplicity) may receive signals 124 from one or more Earth orbiting space vehicles (SVs) 112 (e.g., satellites). In some aspects, the SVs 112 may be part of a satellite positioning system that a UE 104 can use as an independent source of location information. A satellite positioning system typically includes a system of transmitters (e.g., SVs 112) positioned to enable receivers (e.g., UEs 104) to determine their location on or above the Earth based, at least in part, on positioning signals (e.g., signals 124) received from the transmitters. Such a transmitter typically transmits a signal marked with a repeating pseudo-random noise (PN) code of a set number of chips. While typically located in SVs 112, transmitters may sometimes be located on ground-based control stations, base stations 102, and/or other UEs 104. A UE 104 may include one or more dedicated receivers specifically designed to receive signals 124 for deriving geo location information from the SVs 112.

In a satellite positioning system, the use of signals 124 can be augmented by various satellite-based augmentation systems (SBAS) that may be associated with or otherwise enabled for use with one or more global and/or regional navigation satellite systems. For example an SBAS may include an augmentation system(s) that provides integrity information, differential corrections, etc., such as the Wide Area Augmentation System (WAAS), the European Geostationary Navigation Overlay Service (EGNOS), the Multi-functional Satellite Augmentation System (MSAS), the Global Positioning System (GPS) Aided Geo Augmented Navigation or GPS and Geo Augmented Navigation system (GAGAN), and/or the like. Thus, as used herein, a satellite positioning system may include any combination of one or more global and/or regional navigation satellites associated with such one or more satellite positioning systems.

In some aspects, SVs 112 may additionally or alternatively be part of one or more non-terrestrial networks (NTNs). In an NTN, an SV 112 is connected to an earth station (also referred to as a ground station, NTN gateway, or gateway), which in turn is connected to an element in a 5G network, such as a modified base station 102 (without a terrestrial antenna) or a network node in a 5GC. This element would in turn provide access to other elements in the 5G network and ultimately to entities external to the 5G network, such as Internet web servers and other user devices. In that way, a UE 104 may receive communication signals (e.g., signals 124) from an SV 112 instead of, or in addition to, communication signals from a terrestrial base station 102.

Leveraging the increased data rates and decreased latency of NR, among other things, vehicle-to-everything (V2X) communication technologies are being implemented to support intelligent transportation systems (ITS) applications, such as wireless communications between vehicles (vehicle-to-vehicle (V2V)), between vehicles and the roadside infrastructure (vehicle-to-infrastructure (V2I)), and between vehicles and pedestrians (vehicle-to-pedestrian (V2P)). The goal is for vehicles to be able to sense the environment around them and communicate that information to other vehicles, infrastructure, and personal mobile devices. Such vehicle communication will enable safety, mobility, and environmental advancements that current technologies are unable to provide. Once fully implemented, the technology is expected to reduce unimpaired vehicle crashes by 80%.

Still referring to FIG. 1, the wireless communications system 100 may include multiple V-UEs 160 that may communicate with base stations 102 over communication links 120 using the Uu interface (i.e., the air interface between a UE and a base station). V-UEs 160 may also communicate directly with each other over a wireless sidelink 162, with a roadside unit (RSU) 164 (a roadside access point) over a wireless sidelink 166, or with sidelink-capable UEs 104 over a wireless sidelink 168 using the PC5 interface (i.e., the air interface between sidelink-capable UEs). A wireless sidelink (or just “sidelink”) is an adaptation of the core cellular (e.g., LTE, NR) standard that allows direct communication between two or more UEs without the communication needing to go through a base station. Sidelink communication may be unicast or multicast, and may be used for device-to-device (D2D) media-sharing, V2V communication, V2X communication (e.g., cellular V2X (cV2X) communication, enhanced V2X (eV2X) communication, etc.), emergency rescue applications, etc. One or more of a group of V-UEs 160 utilizing sidelink communications may be within the geographic coverage area 110 of a base station 102. Other V-UEs 160 in such a group may be outside the geographic coverage area 110 of a base station 102 or be otherwise unable to receive transmissions from a base station 102. In some cases, groups of V-UEs 160 communicating via sidelink communications may utilize a one-to-many (1:M) system in which each V-UE 160 transmits to every other V-UE 160 in the group. In some cases, a base station 102 facilitates the scheduling of resources for sidelink communications. In other cases, sidelink communications are carried out between V-UEs 160 without the involvement of a base station 102.

In some aspects, the sidelinks 162, 166, 168 may operate over a wireless communication medium of interest, which may be shared with other wireless communications between other vehicles and/or infrastructure access points, as well as other RATs. A “medium” may be composed of one or more time, frequency, and/or space communication resources (e.g., encompassing one or more channels across one or more carriers) associated with wireless communication between one or more transmitter/receiver pairs.

In some aspects, the sidelinks 162, 166, 168 may be cV2X links. A first generation of cV2X has been standardized in LTE, and the next generation is expected to be defined in NR. cV2X is a cellular technology that also enables device-to-device communications. In the U.S. and Europe, cV2X is expected to operate in the licensed ITS band in sub-6 GHz. Other bands may be allocated in other countries. Thus, as a particular example, the medium of interest utilized by sidelinks 162, 166, 168 may correspond to at least a portion of the licensed ITS frequency band of sub-6 GHZ. However, the present disclosure is not limited to this frequency band or cellular technology.

In some aspects, the sidelinks 162, 166, 168 may be dedicated short-range communications (DSRC) links. DSRC is a one-way or two-way short-range to medium-range wireless communication protocol that uses the wireless access for vehicular environments (WAVE) protocol, also known as IEEE 802.11p, for V2V, V2I, and V2P communications. IEEE 802.11p is an approved amendment to the IEEE 802.11 standard and operates in the licensed ITS band of 5.9 GHZ (5.85-5.925 GHZ) in the U.S. In Europe, IEEE 802.11p operates in the ITS G5A band (5.875-5.905 MHz). Other bands may be allocated in other countries. The V2V communications briefly described above occur on the Safety Channel, which in the U.S. is typically a 10 MHz channel that is dedicated to the purpose of safety. The remainder of the DSRC band (the total bandwidth is 75 MHz) is intended for other services of interest to drivers, such as road rules, tolling, parking automation, etc. Thus, as a particular example, the mediums of interest utilized by sidelinks 162, 166, 168 may correspond to at least a portion of the licensed ITS frequency band of 5.9 GHZ.

Alternatively, the medium of interest may correspond to at least a portion of an unlicensed frequency band shared among various RATs. Although different licensed frequency bands have been reserved for certain communication systems (e.g., by a government entity such as the Federal Communications Commission (FCC) in the United States), these systems, in particular those employing small cell access points, have recently extended operation into unlicensed frequency bands such as the Unlicensed National Information Infrastructure (U-NII) band used by wireless local area network (WLAN) technologies, most notably IEEE 802.11x WLAN technologies generally referred to as “Wi-Fi.” Example systems of this type include different variants of CDMA systems, TDMA systems, FDMA systems, orthogonal FDMA (OFDMA) systems, single-carrier FDMA (SC-FDMA) systems, and so on.

Communications between the V-UEs 160 are referred to as V2V communications, communications between the V-UEs 160 and the one or more RSUs 164 are referred to as V2I communications, and communications between the V-UEs 160 and one or more UEs 104 (where the UEs 104 are P-UEs) are referred to as V2P communications. The V2V communications between V-UEs 160 may include, for example, information about the position, speed, acceleration, heading, and other vehicle data of the V-UEs 160. The V2I information received at a V-UE 160 from the one or more RSUs 164 may include, for example, road rules, parking automation information, etc. The V2P communications between a V-UE 160 and a UE 104 may include information about, for example, the position, speed, acceleration, and heading of the V-UE 160 and the position, speed (e.g., where the UE 104 is carried by a user on a bicycle), and heading of the UE 104.

Note that although FIG. 1 only illustrates two of the UEs as V-UEs (V-UEs 160), any of the illustrated UEs (e.g., UEs 104, 152, 182, 190) may be V-UEs. In addition, while only the V-UEs 160 and a single UE 104 have been illustrated as being connected over a sidelink, any of the UEs illustrated in FIG. 1, whether V-UEs, P-UEs, etc., may be capable of sidelink communication. Further, although only UE 182 was described as being capable of beam forming, any of the illustrated UEs, including V-UEs 160, may be capable of beam forming. Where V-UEs 160 are capable of beam forming, they may beam form towards each other (i.e., towards other V-UEs 160), towards RSUs 164, towards other UEs (e.g., UEs 104, 152, 182, 190), etc. Thus, in some cases, V-UEs 160 may utilize beamforming over sidelinks 162, 166, and 168.

The wireless communications system 100 may further include one or more UEs, such as UE 190, that connects indirectly to one or more communication networks via one or more device-to-device (D2D) peer-to-peer (P2P) links. In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), WI-FI DIRECT®, BLUETOOTH®, and so on. As another example, the D2D P2P links 192 and 194 may be sidelinks, as described above with reference to sidelinks 162, 166, and 168.

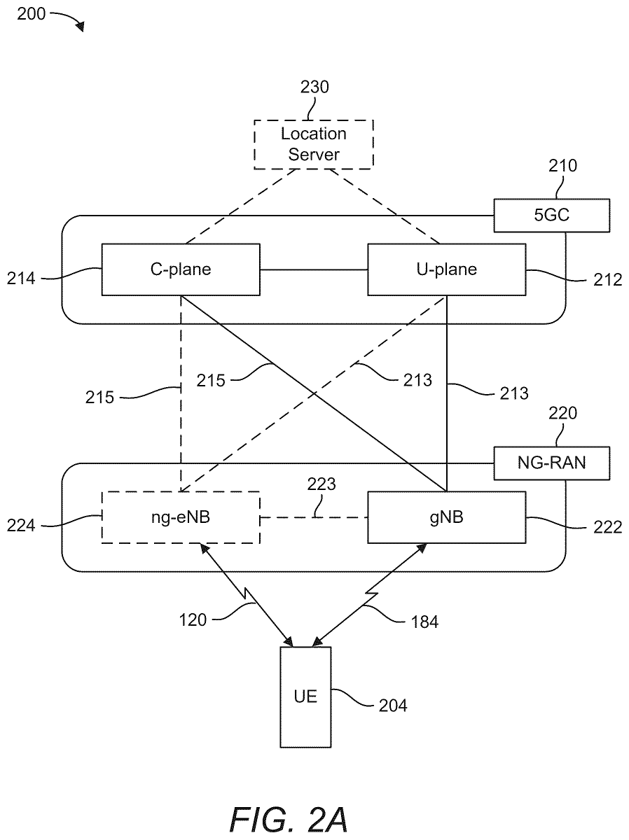

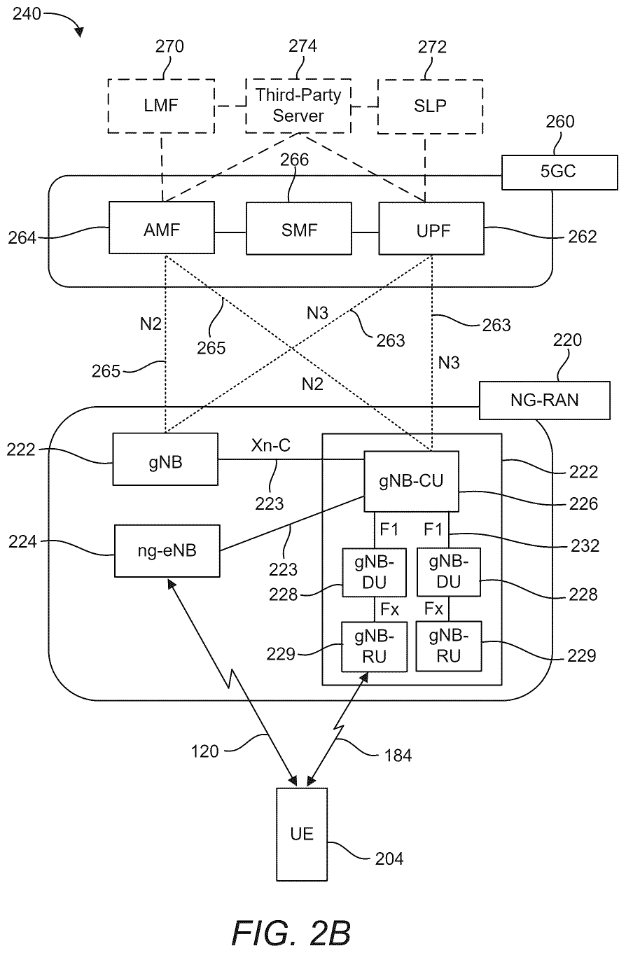

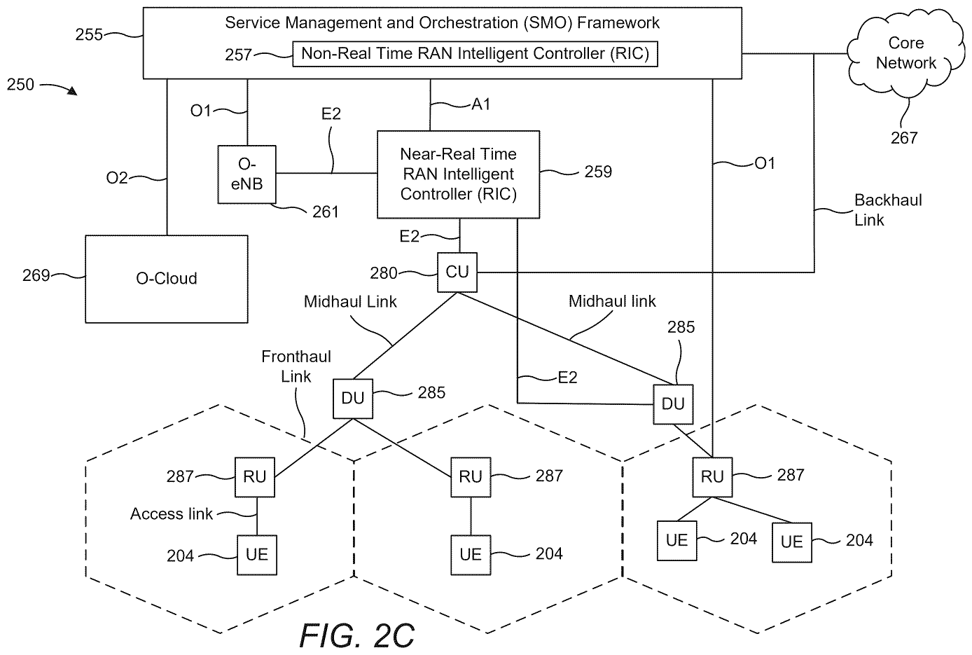

FIG. 2A illustrates an example wireless network structure 200. For example, a 5GC 210 (also referred to as a Next Generation Core (NGC)) can be viewed functionally as control plane (C-plane) functions 214 (e.g., UE registration, authentication, network access, gateway selection, etc.) and user plane (U-plane) functions 212, (e.g., UE gateway function, access to data networks, IP routing, etc.) which operate cooperatively to form the core network. User plane interface (NG-U) 213 and control plane interface (NG-C) 215 connect the gNB 222 to the 5GC 210 and specifically to the user plane functions 212 and control plane functions 214, respectively. In an additional configuration, an ng-eNB 224 may also be connected to the 5GC 210 via NG-C 215 to the control plane functions 214 and NG-U 213 to user plane functions 212. Further, ng-eNB 224 may directly communicate with gNB 222 via a backhaul connection 223. In some configurations, a Next Generation RAN (NG-RAN) 220 may have one or more gNBs 222, while other configurations include one or more of both ng-eNBs 224 and gNBs 222. Either (or both) gNB 222 or ng-eNB 224 may communicate with one or more UEs 204 (e.g., any of the UEs described herein).

Another optional aspect may include a location server 230, which may be in communication with the 5GC 210 to provide location assistance for UE(s) 204. The location server 230 can be implemented as a plurality of separate servers (e.g., physically separate servers, different software modules on a single server, different software modules spread across multiple physical servers, etc.), or alternately may each correspond to a single server. The location server 230 can be configured to support one or more location services for UEs 204 that can connect to the location server 230 via the core network, 5GC 210, and/or via the Internet (not illustrated). Further, the location server 230 may be integrated into a component of the core network, or alternatively may be external to the core network (e.g., a third party server, such as an original equipment manufacturer (OEM) server or service server).

FIG. 2B illustrates another example wireless network structure 240. A 5GC 260 (which may correspond to 5GC 210 in FIG. 2A) can be viewed functionally as control plane functions, provided by an access and mobility management function (AMF) 264, and user plane functions, provided by a user plane function (UPF) 262, which operate cooperatively to form the core network (i.e., 5GC 260). The functions of the AMF 264 include registration management, connection management, reachability management, mobility management, lawful interception, transport for session management (SM) messages between one or more UEs 204 (e.g., any of the UEs described herein) and a session management function (SMF) 266, transparent proxy services for routing SM messages, access authentication and access authorization, transport for short message service (SMS) messages between the UE 204 and the short message service function (SMSF) (not shown), and security anchor functionality (SEAF). The AMF 264 also interacts with an authentication server function (AUSF) (not shown) and the UE 204, and receives the intermediate key that was established as a result of the UE 204 authentication process. In the case of authentication based on a UMTS (universal mobile telecommunications system) subscriber identity module (USIM), the AMF 264 retrieves the security material from the AUSF. The functions of the AMF 264 also include security context management (SCM). The SCM receives a key from the SEAF that it uses to derive access-network specific keys. The functionality of the AMF 264 also includes location services management for regulatory services, transport for location services messages between the UE 204 and a location management function (LMF) 270 (which acts as a location server 230), transport for location services messages between the NG-RAN 220 and the LMF 270, evolved packet system (EPS) bearer identifier allocation for interworking with the EPS, and UE 204 mobility event notification. In addition, the AMF 264 also supports functionalities for non-3GPP® (Third Generation Partnership Project) access networks.

Functions of the UPF 262 include acting as an anchor point for intra/inter-RAT mobility (when applicable), acting as an external protocol data unit (PDU) session point of interconnect to a data network (not shown), providing packet routing and forwarding, packet inspection, user plane policy rule enforcement (e.g., gating, redirection, traffic steering), lawful interception (user plane collection), traffic usage reporting, quality of service (QoS) handling for the user plane (e.g., uplink/downlink rate enforcement, reflective QoS marking in the downlink), uplink traffic verification (service data flow (SDF) to QoS flow mapping), transport level packet marking in the uplink and downlink, downlink packet buffering and downlink data notification triggering, and sending and forwarding of one or more “end markers” to the source RAN node. The UPF 262 may also support transfer of location services messages over a user plane between the UE 204 and a location server, such as an SLP 272.

The functions of the SMF 266 include session management, UE Internet protocol (IP) address allocation and management, selection and control of user plane functions, configuration of traffic steering at the UPF 262 to route traffic to the proper destination, control of part of policy enforcement and QoS, and downlink data notification. The interface over which the SMF 266 communicates with the AMF 264 is referred to as the N11 interface.

Another optional aspect may include an LMF 270, which may be in communication with the 5GC 260 to provide location assistance for UEs 204. The LMF 270 can be implemented as a plurality of separate servers (e.g., physically separate servers, different software modules on a single server, different software modules spread across multiple physical servers, etc.), or alternately may each correspond to a single server. The LMF 270 can be configured to support one or more location services for UEs 204 that can connect to the LMF 270 via the core network, 5GC 260, and/or via the Internet (not illustrated). The SLP 272 may support similar functions to the LMF 270, but whereas the LMF 270 may communicate with the AMF 264, NG-RAN 220, and UEs 204 over a control plane (e.g., using interfaces and protocols intended to convey signaling messages and not voice or data), the SLP 272 may communicate with UEs 204 and external clients (e.g., third-party server 274) over a user plane (e.g., using protocols intended to carry voice and/or data like the transmission control protocol (TCP) and/or IP).

Yet another optional aspect may include a third-party server 274, which may be in communication with the LMF 270, the SLP 272, the 5GC 260 (e.g., via the AMF 264 and/or the UPF 262), the NG-RAN 220, and/or the UE 204 to obtain location information (e.g., a location estimate) for the UE 204. As such, in some cases, the third-party server 274 may be referred to as a location services (LCS) client or an external client. The third-party server 274 can be implemented as a plurality of separate servers (e.g., physically separate servers, different software modules on a single server, different software modules spread across multiple physical servers, etc.), or alternately may each correspond to a single server.

User plane interface 263 and control plane interface 265 connect the 5GC 260, and specifically the UPF 262 and AMF 264, respectively, to one or more gNBs 222 and/or ng-eNBs 224 in the NG-RAN 220. The interface between gNB(s) 222 and/or ng-eNB(s) 224 and the AMF 264 is referred to as the “N2” interface, and the interface between gNB(s) 222 and/or ng-eNB(s) 224 and the UPF 262 is referred to as the “N3” interface. The gNB(s) 222 and/or ng-eNB(s) 224 of the NG-RAN 220 may communicate directly with each other via backhaul connections 223, referred to as the “Xn-C” interface. One or more of gNBs 222 and/or ng-eNBs 224 may communicate with one or more UEs 204 over a wireless interface, referred to as the “Uu” interface.

The functionality of a gNB 222 may be divided between a gNB central unit (gNB-CU) 226, one or more gNB distributed units (gNB-DUs) 228, and one or more gNB radio units (gNB-RUs) 229. A gNB-CU 226 is a logical node that includes the base station functions of transferring user data, mobility control, radio access network sharing, positioning, session management, and the like, except for those functions allocated exclusively to the gNB-DU(s) 228. More specifically, the gNB-CU 226 generally host the radio resource control (RRC), service data adaptation protocol (SDAP), and packet data convergence protocol (PDCP) protocols of the gNB 222. A gNB-DU 228 is a logical node that generally hosts the radio link control (RLC) and medium access control (MAC) layer of the gNB 222. Its operation is controlled by the gNB-CU 226. One gNB-DU 228 can support one or more cells, and one cell is supported by only one gNB-DU 228. The interface 232 between the gNB-CU 226 and the one or more gNB-DUs 228 is referred to as the “F1” interface. The physical (PHY) layer functionality of a gNB 222 is generally hosted by one or more standalone gNB-RUs 229 that perform functions such as power amplification and signal transmission/reception. The interface between a gNB-DU 228 and a gNB-RU 229 is referred to as the “Fx” interface. Thus, a UE 204 communicates with the gNB-CU 226 via the RRC, SDAP, and PDCP layers, with a gNB-DU 228 via the RLC and MAC layers, and with a gNB-RU 229 via the PHY layer.

Deployment of communication systems, such as 5G NR systems, may be arranged in multiple manners with various components or constituent parts. In a 5G NR system, or network, a network node, a network entity, a mobility element of a network, a RAN node, a core network node, a network element, or a network equipment, such as a base station, or one or more units (or one or more components) performing base station functionality, may be implemented in an aggregated or disaggregated architecture. For example, a base station (such as a Node B (NB), evolved NB (eNB), NR base station, 5G NB, AP, TRP, cell, etc.) may be implemented as an aggregated base station (also known as a standalone base station or a monolithic base station) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN ALLIANCE®)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

FIG. 2C illustrates an example disaggregated base station architecture 250, according to aspects of the disclosure. The disaggregated base station architecture 250 may include one or more central units (CUs) 280 (e.g., gNB-CU 226) that can communicate directly with a core network 267 (e.g., 5GC 210, 5GC 260) via a backhaul link, or indirectly with the core network 267 through one or more disaggregated base station units (such as a Near-Real Time (Near-RT) RAN Intelligent Controller (RIC) 259 via an E2 link, or a Non-Real Time (Non-RT) RIC 257 associated with a Service Management and Orchestration (SMO) Framework 255, or both). A CU 280 may communicate with one or more DUs 285 (e.g., gNB-DUs 228) via respective midhaul links, such as an F1 interface. The DUs 285 may communicate with one or more radio units (RUs) 287 (e.g., gNB-RUs 229) via respective fronthaul links. The RUs 287 may communicate with respective UEs 204 via one or more radio frequency (RF) access links. In some implementations, the UE 204 may be simultaneously served by multiple RUs 287.

Each of the units, i.e., the CUS 280, the DUs 285, the RUs 287, as well as the Near-RT RICs 259, the Non-RT RICs 257 and the SMO Framework 255, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a RF transceiver), configured to receive or transmit signals, or both, over a wireless transmission medium to one or more of the other units.

In some aspects, the CU 280 may host one or more higher layer control functions. Such control functions can include RRC, PDCP, service data adaptation protocol (SDAP), or the like. Each control function can be implemented with an interface configured to communicate signals with other control functions hosted by the CU 280. The CU 280 may be configured to handle user plane functionality (i.e., Central Unit-User Plane (CU-UP)), control plane functionality (i.e., Central Unit-Control Plane (CU-CP)), or a combination thereof. In some implementations, the CU 280 can be logically split into one or more CU-UP units and one or more CU-CP units. The CU-UP unit can communicate bidirectionally with the CU-CP unit via an interface, such as the E1 interface when implemented in an O-RAN configuration. The CU 280 can be implemented to communicate with the DU 285, as necessary, for network control and signaling.

The DU 285 may correspond to a logical unit that includes one or more base station functions to control the operation of one or more RUs 287. In some aspects, the DU 285 may host one or more of a RLC layer, a MAC layer, and one or more high PHY layers (such as modules for forward error correction (FEC) encoding and decoding, scrambling, modulation and demodulation, or the like) depending, at least in part, on a functional split, such as those defined by the 3rd Generation Partnership Project (3GPP®). In some aspects, the DU 285 may further host one or more low PHY layers. Each layer (or module) can be implemented with an interface configured to communicate signals with other layers (and modules) hosted by the DU 285, or with the control functions hosted by the CU 280.

Lower-layer functionality can be implemented by one or more RUs 287. In some deployments, an RU 287, controlled by a DU 285, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 287 can be implemented to handle over the air (OTA) communication with one or more UEs 204. In some implementations, real-time and non-real-time aspects of control and user plane communication with the RU(s) 287 can be controlled by the corresponding DU 285. In some scenarios, this configuration can enable the DU(s) 285 and the CU 280 to be implemented in a cloud-based RAN architecture, such as a vRAN architecture.

The SMO Framework 255 may be configured to support RAN deployment and provisioning of non-virtualized and virtualized network elements. For non-virtualized network elements, the SMO Framework 255 may be configured to support the deployment of dedicated physical resources for RAN coverage requirements which may be managed via an operations and maintenance interface (such as an O1 interface). For virtualized network elements, the SMO Framework 255 may be configured to interact with a cloud computing platform (such as an open cloud (O-Cloud) 269) to perform network element life cycle management (such as to instantiate virtualized network elements) via a cloud computing platform interface (such as an O2 interface). Such virtualized network elements can include, but are not limited to, CUs 280, DUs 285, RUS 287 and Near-RT RICs 259. In some implementations, the SMO Framework 255 can communicate with a hardware aspect of a 4G RAN, such as an open eNB (O-eNB) 261, via an O1 interface. Additionally, in some implementations, the SMO Framework 255 can communicate directly with one or more RUs 287 via an O1 interface. The SMO Framework 255 also may include a Non-RT RIC 257 configured to support functionality of the SMO Framework 255.

The Non-RT RIC 257 may be configured to include a logical function that enables non-real-time control and optimization of RAN elements and resources, artificial intelligence/machine learning (AI/ML) workflows including model training and updates, or policy-based guidance of applications/features in the Near-RT RIC 259. The Non-RT RIC 257 may be coupled to or communicate with (such as via an A1 interface) the Near-RT RIC 259. The Near-RT RIC 259 may be configured to include a logical function that enables near-real-time control and optimization of RAN elements and resources via data collection and actions over an interface (such as via an E2 interface) connecting one or more CUs 280, one or more DUs 285, or both, as well as an O-eNB, with the Near-RT RIC 259.

In some implementations, to generate AI/ML models to be deployed in the Near-RT RIC 259, the Non-RT RIC 257 may receive parameters or external enrichment information from external servers. Such information may be utilized by the Near-RT RIC 259 and may be received at the SMO Framework 255 or the Non-RT RIC 257 from non-network data sources or from network functions. In some examples, the Non-RT RIC 257 or the Near-RT RIC 259 may be configured to tune RAN behavior or performance. For example, the Non-RT RIC 257 may monitor long-term trends and patterns for performance and employ AI/ML models to perform corrective actions through the SMO Framework 255 (such as reconfiguration via 01) or via creation of RAN management policies (such as A1 policies).

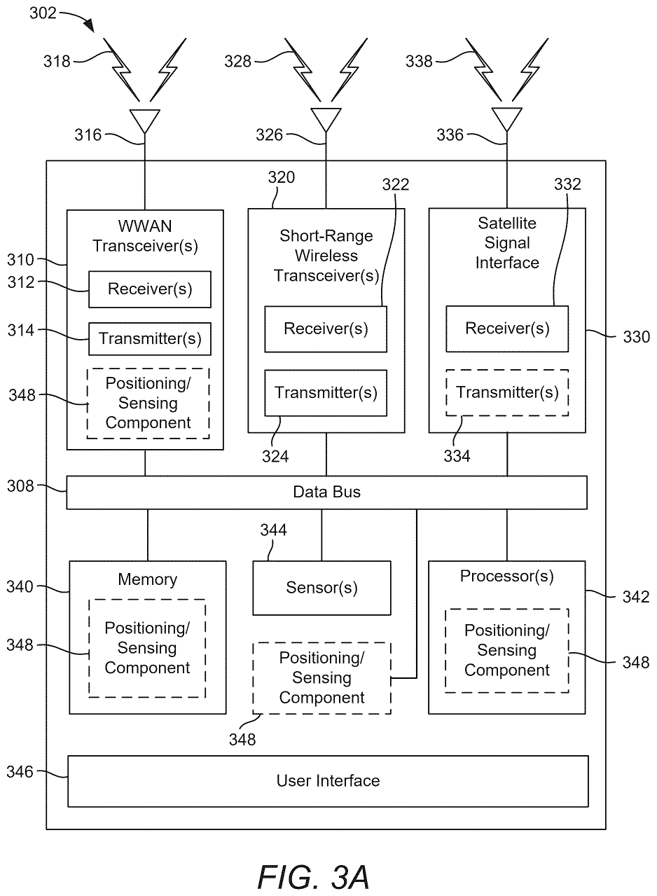

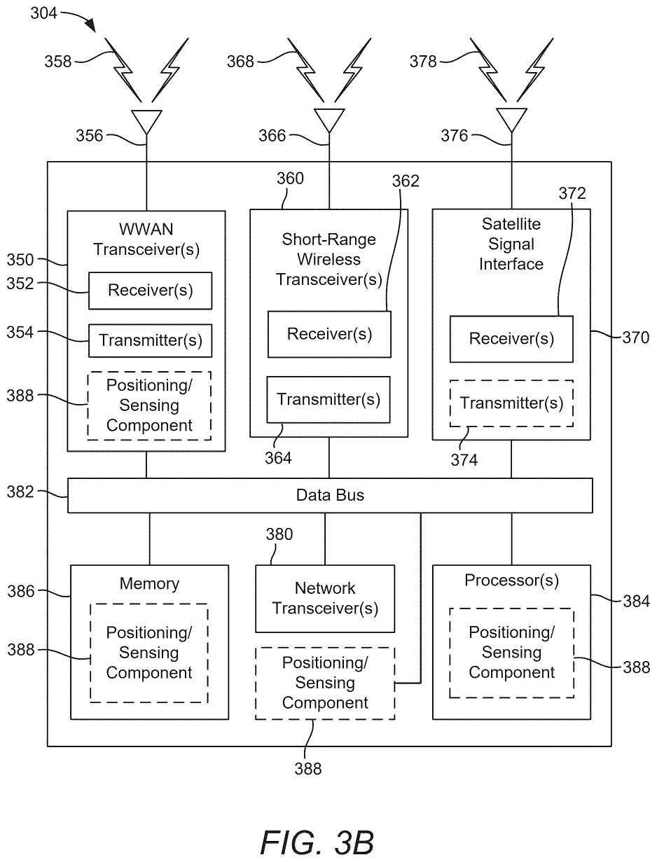

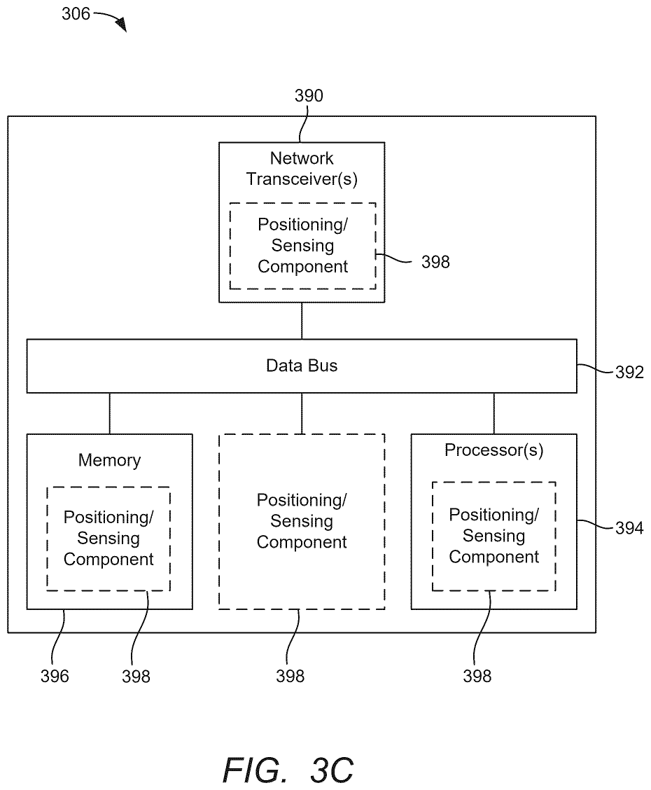

FIGS. 3A, 3B, and 3C illustrate several example components (represented by corresponding blocks) that may be incorporated into a UE 302 (which may correspond to any of the UEs described herein), a base station 304 (which may correspond to any of the base stations described herein), and a network entity 306 (which may correspond to or embody any of the network functions described herein, including the location server 230 and the LMF 270, or alternatively may be independent from the NG-RAN 220 and/or 5GC 210/260 infrastructure depicted in FIGS. 2A and 2B, such as a private network) to support the operations described herein. It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 302 and the base station 304 each include one or more wireless wide area network (WWAN) transceivers 310 and 350, respectively, providing means for communicating (e.g., means for transmitting, means for receiving, means for measuring, means for tuning, means for refraining from transmitting, etc.) via one or more wireless communication networks (not shown), such as an NR network, an LTE network, a GSM network, and/or the like. The WWAN transceivers 310 and 350 may each be connected to one or more antennas 316 and 356, respectively, for communicating with other network nodes, such as other UEs, access points, base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The WWAN transceivers 310 and 350 may be variously configured for transmitting and encoding signals 318 and 358 (e.g., messages, indications, information, and so on), respectively, and, conversely, for receiving and decoding signals 318 and 358 (e.g., messages, indications, information, pilots, and so on), respectively, in accordance with the designated RAT. Specifically, the WWAN transceivers 310 and 350 include one or more transmitters 314 and 354, respectively, for transmitting and encoding signals 318 and 358, respectively, and one or more receivers 312 and 352, respectively, for receiving and decoding signals 318 and 358, respectively.

The UE 302 and the base station 304 each also include, at least in some cases, one or more short-range wireless transceivers 320 and 360, respectively. The short-range wireless transceivers 320 and 360 may be connected to one or more antennas 326 and 366, respectively, and provide means for communicating (e.g., means for transmitting, means for receiving, means for measuring, means for tuning, means for refraining from transmitting, etc.) with other network nodes, such as other UEs, access points, base stations, etc., via at least one designated RAT (e.g., Wi-Fi, LTE Direct, BLUETOOTH®, ZIGBEE®, Z-WAVE®, PC5, dedicated short-range communications (DSRC), wireless access for vehicular environments (WAVE), near-field communication (NFC), ultra-wideband (UWB), etc.) over a wireless communication medium of interest. The short-range wireless transceivers 320 and 360 may be variously configured for transmitting and encoding signals 328 and 368 (e.g., messages, indications, information, and so on), respectively, and, conversely, for receiving and decoding signals 328 and 368 (e.g., messages, indications, information, pilots, and so on), respectively, in accordance with the designated RAT. Specifically, the short-range wireless transceivers 320 and 360 include one or more transmitters 324 and 364, respectively, for transmitting and encoding signals 328 and 368, respectively, and one or more receivers 322 and 362, respectively, for receiving and decoding signals 328 and 368, respectively. As specific examples, the short-range wireless transceivers 320 and 360 may be Wi-Fi transceivers, BLUETOOTH® transceivers, ZIGBEE® and/or Z-WAVE® transceivers, NFC transceivers, UWB transceivers, or vehicle-to-vehicle (V2V) and/or vehicle-to-everything (V2X) transceivers.

The UE 302 and the base station 304 also include, at least in some cases, satellite signal interfaces 330 and 370, which each include one or more satellite signal receivers 332 and 372, respectively, and may optionally include one or more satellite signal transmitters 334 and 374, respectively. In some cases, the base station 304 may be a terrestrial base station that may communicate with space vehicles (e.g., space vehicles 112) via the satellite signal interface 370. In other cases, the base station 304 may be a space vehicle (or other non-terrestrial entity) that uses the satellite signal interface 370 to communicate with terrestrial networks and/or other space vehicles.

The satellite signal receivers 332 and 372 may be connected to one or more antennas 336 and 376, respectively, and may provide means for receiving and/or measuring satellite positioning/communication signals 338 and 378, respectively. Where the satellite signal receiver(s) 332 and 372 are satellite positioning system receivers, the satellite positioning/communication signals 338 and 378 may be global positioning system (GPS) signals, global navigation satellite system (GLONASS) signals, Galileo signals, Beidou signals, Indian Regional Navigation Satellite System (NAVIC), Quasi-Zenith Satellite System (QZSS) signals, etc. Where the satellite signal receiver(s) 332 and 372 are non-terrestrial network (NTN) receivers, the satellite positioning/communication signals 338 and 378 may be communication signals (e.g., carrying control and/or user data) originating from a 5G network. The satellite signal receiver(s) 332 and 372 may comprise any suitable hardware and/or software for receiving and processing satellite positioning/communication signals 338 and 378, respectively. The satellite signal receiver(s) 332 and 372 may request information and operations as appropriate from the other systems, and, at least in some cases, perform calculations to determine locations of the UE 302 and the base station 304, respectively, using measurements obtained by any suitable satellite positioning system algorithm.

The optional satellite signal transmitter(s) 334 and 374, when present, may be connected to the one or more antennas 336 and 376, respectively, and may provide means for transmitting satellite positioning/communication signals 338 and 378, respectively. Where the satellite signal transmitter(s) 374 are satellite positioning system transmitters, the satellite positioning/communication signals 378 may be GPS signals, GLONASS® signals, Galileo signals, Beidou signals, NAVIC, QZSS signals, etc. Where the satellite signal transmitter(s) and 334 374 are e NTN transmitters, the satellite positioning/communication signals 338 and 378 may be communication signals (e.g., carrying control and/or user data) originating from a 5G network. The satellite signal transmitter(s) 334 and 374 may comprise any suitable hardware and/or software for transmitting satellite positioning/communication signals 338 and 378, respectively. The satellite signal transmitter(s) 334 and 374 may request information and operations as appropriate from the other systems.

The base station 304 and the network entity 306 each include one or more network transceivers 380 and 390, respectively, providing means for communicating (e.g., means for transmitting, means for receiving, etc.) with other network entities (e.g., other base stations 304, other network entities 306). For example, the base station 304 may employ the one or more network transceivers 380 to communicate with other base stations 304 or network entities 306 over one or more wired or wireless backhaul links. As another example, the network entity 306 may employ the one or more network transceivers 390 to communicate with one or more base station 304 over one or more wired or wireless backhaul links, or with other network entities 306 over one or more wired or wireless core network interfaces.

A transceiver may be configured to communicate over a wired or wireless link. A transceiver (whether a wired transceiver or a wireless transceiver) includes transmitter circuitry (e.g., transmitters 314, 324, 354, 364) and receiver circuitry (e.g., receivers 312, 322, 352, 362). A transceiver may be an integrated device (e.g., embodying transmitter circuitry and receiver circuitry in a single device) in some implementations, may comprise separate transmitter circuitry and separate receiver circuitry in some implementations, or may be embodied in other ways in other implementations. The transmitter circuitry and receiver circuitry of a wired transceiver (e.g., network transceivers 380 and 390 in some implementations) may be coupled to one or more wired network interface ports. Wireless transmitter circuitry (e.g., transmitters 314, 324, 354, 364) may include or be coupled to a plurality of antennas (e.g., antennas 316, 326, 356, 366), such as an antenna array, that permits the respective apparatus (e.g., UE 302, base station 304) to perform transmit “beamforming,” as described herein. Similarly, wireless receiver circuitry (e.g., receivers 312, 322, 352, 362) may include or be coupled to a plurality of antennas (e.g., antennas 316, 326, 356, 366), such as an antenna array, that permits the respective apparatus (e.g., UE 302, base station 304) to perform receive beamforming, as described herein. In some aspects, the transmitter circuitry and receiver circuitry may share the same plurality of antennas (e.g., antennas 316, 326, 356, 366), such that the respective apparatus can only receive or transmit at a given time, not both at the same time. A wireless transceiver (e.g., WWAN transceivers 310 and 350, short-range wireless transceivers 320 and 360) may also include a network listen module (NLM) or the like for performing various measurements.

As used herein, the various wireless transceivers (e.g., transceivers 310, 320, 350, and 360, and network transceivers 380 and 390 in some implementations) and wired transceivers (e.g., network transceivers 380 and 390 in some implementations) may generally be characterized as “a transceiver,” “at least one transceiver,” or “one or more transceivers.” As such, whether a particular transceiver is a wired or wireless transceiver may be inferred from the type of communication performed. For example, backhaul communication between network devices or servers will generally relate to signaling via a wired transceiver, whereas wireless communication between a UE (e.g., UE 302) and a base station (e.g., base station 304) will generally relate to signaling via a wireless transceiver.

The UE 302, the base station 304, and the network entity 306 also include other components that may be used in conjunction with the operations as disclosed herein. The UE 302, the base station 304, and the network entity 306 include one or more processors 342, 384, and 394, respectively, for providing functionality relating to, for example, wireless communication, and for providing other processing functionality. The processors 342, 384, and 394 may therefore provide means for processing, such as means for determining, means for calculating, means for receiving, means for transmitting, means for indicating, etc. In some aspects, the processors 342, 384, and 394 may include, for example, one or more general purpose processors, multi-core processors, central processing units (CPUs), ASICs, digital signal processors (DSPs), field programmable gate arrays (FPGAs), other programmable logic devices or processing circuitry, or various combinations thereof.

The UE 302, the base station 304, and the network entity 306 include memory circuitry implementing memories 340, 386, and 396 (e.g., each including a memory device), respectively, for maintaining information (e.g., information indicative of reserved resources, thresholds, parameters, and so on). The memories 340, 386, and 396 may therefore provide means for storing, means for retrieving, means for maintaining, etc. In some cases, the UE 302, the base station 304, and the network entity 306 may include positioning/sensing component 348, 388, and 398, respectively. The positioning/sensing component 348, 388, and 398 may be hardware circuits that are part of or coupled to the processors 342, 384, and 394, respectively, that, when executed, cause the UE 302, the base station 304, and the network entity 306 to perform the functionality described herein. In other aspects, the positioning/sensing component 348, 388, and 398 may be external to the processors 342, 384, and 394 (e.g., part of a modem processing system, integrated with another processing system, etc.). Alternatively, the positioning/sensing component 348, 388, and 398 may be memory modules stored in the memories 340, 386, and 396, respectively, that, when executed by the processors 342, 384, and 394 (or a modem processing system, another processing system, etc.), cause the UE 302, the base station 304, and the network entity 306 to perform the functionality described herein. FIG. 3A illustrates possible locations of the positioning/sensing component 348, which may be, for example, part of the one or more WWAN transceivers 310, the memory 340, the one or more processors 342, or any combination thereof, or may be a standalone component. FIG. 3B illustrates possible locations of the positioning/sensing component 388, which may be, for example, part of the one or more WWAN transceivers 350, the memory 386, the one or more processors 384, or any combination thereof, or may be a standalone component. FIG. 3C illustrates possible locations of the positioning/sensing component 398, which may be, for example, part of the one or more network transceivers 390, the memory 396, the one or more processors 394, or any combination thereof, or may be a standalone component.

The UE 302 may include one or more sensors 344 coupled to the one or more processors 342 to provide means for sensing or detecting movement and/or orientation information that is independent of motion data derived from signals received by the one or more WWAN transceivers 310, the one or more short-range wireless transceivers 320, and/or the satellite signal interface 330. By way of example, the sensor(s) 344 may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the sensor(s) 344 may include a plurality of different types of devices and combine their outputs in order to provide motion information. For example, the sensor(s) 344 may use a combination of a multi-axis accelerometer and orientation sensors to provide the ability to compute positions in two-dimensional (2D) and/or three-dimensional (3D) coordinate systems.

In addition, the UE 302 includes a user interface 346 providing means for providing indications (e.g., audible and/or visual indications) to a user and/or for receiving user input (e.g., upon user actuation of a sensing device such a keypad, a touch screen, a microphone, and so on). Although not shown, the base station 304 and the network entity 306 may also include user interfaces.

Referring to the one or more processors 384 in more detail, in the downlink, IP packets from the network entity 306 may be provided to the processor 384. The one or more processors 384 may implement functionality for an RRC layer, a packet data convergence protocol (PDCP) layer, a radio link control (RLC) layer, and a medium access control (MAC) layer. The one or more processors 384 may provide RRC layer functionality associated with broadcasting of system information (e.g., master information block (MIB), system information blocks (SIBs)), RRC connection control (e.g., RRC connection paging, RRC connection establishment, RRC connection modification, and RRC connection release), inter-RAT mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer PDUs, error correction through automatic repeat request (ARQ), concatenation, segmentation, and reassembly of RLC service data units (SDUs), re-segmentation of RLC data PDUs, and reordering of RLC data PDUs; and MAC layer functionality associated with mapping between logical channels and transport channels, scheduling information reporting, error correction, priority handling, and logical channel prioritization.

The transmitter 354 and the receiver 352 may implement Layer-1 (L1) functionality associated with various signal processing functions. Layer-1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The transmitter 354 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an orthogonal frequency division multiplexing (OFDM) subcarrier, multiplexed with a reference signal (e.g., pilot) in the time and/or frequency domain, and then combined together using an inverse fast Fourier transform (IFFT) to produce a physical channel carrying a time domain OFDM symbol stream. The OFDM symbol stream is spatially precoded to produce multiple spatial streams. Channel estimates from a channel estimator may be used to determine the coding and modulation scheme, as well as for spatial processing. The channel estimate may be derived from a reference signal and/or channel condition feedback transmitted by the UE 302. Each spatial stream may then be provided to one or more different antennas 356. The transmitter 354 may modulate an RF carrier with a respective spatial stream for transmission.

At the UE 302, the receiver 312 receives a signal through its respective antenna(s) 316. The receiver 312 recovers information modulated onto an RF carrier and provides the information to the one or more processors 342. The transmitter 314 and the receiver 312 implement Layer-1 functionality associated with various signal processing functions. The receiver 312 may perform spatial processing on the information to recover any spatial streams destined for the UE 302. If multiple spatial streams are destined for the UE 302, they may be combined by the receiver 312 into a single OFDM symbol stream. The receiver 312 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 304. These soft decisions may be based on channel estimates computed by a channel estimator. The soft decisions are then decoded and de-interleaved to recover the data and control signals that were originally transmitted by the base station 304 on the physical channel. The data and control signals are then provided to the one or more processors 342, which implements Layer-3 (L3) and Layer-2 (L2) functionality.

In the downlink, the one or more processors 342 provides demultiplexing between transport and logical channels, packet reassembly, deciphering, header decompression, and control signal processing to recover IP packets from the core network. The one or more processors 342 are also responsible for error detection.

Similar to the functionality described in connection with the downlink transmission by the base station 304, the one or more processors 342 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through hybrid automatic repeat request (HARQ), priority handling, and logical channel prioritization.

Channel estimates derived by the channel estimator from a reference signal or feedback transmitted by the base station 304 may be used by the transmitter 314 to select the appropriate coding and modulation schemes, and to facilitate spatial processing. The spatial streams generated by the transmitter 314 may be provided to different antenna(s) 316. The transmitter 314 may modulate an RF carrier with a respective spatial stream for transmission.

The uplink transmission is processed at the base station 304 in a manner similar to that described in connection with the receiver function at the UE 302. The receiver 352 receives a signal through its respective antenna(s) 356. The receiver 352 recovers information modulated onto an RF carrier and provides the information to the one or more processors 384.

In the uplink, the one or more processors 384 provides demultiplexing between transport and logical channels, packet reassembly, deciphering, header decompression, control signal processing to recover IP packets from the UE 302. IP packets from the one or more processors 384 may be provided to the core network. The one or more processors 384 are also responsible for error detection.

For convenience, the UE 302, the base station 304, and/or the network entity 306 are shown in FIGS. 3A, 3B, and 3C as including various components that may be configured according to the various examples described herein. It will be appreciated, however, that the illustrated components may have different functionality in different designs. In particular, various components in FIGS. 3A to 3C are optional in alternative configurations and the various aspects include configurations that may vary due to design choice, costs, use of the device, or other considerations. For example, in case of FIG. 3A, a particular implementation of UE 302 may omit the WWAN transceiver(s) 310 (e.g., a wearable device or tablet computer or personal computer (PC) or laptop may have Wi-Fi and/or BLUETOOTH® capability without cellular capability), or may omit the short-range wireless transceiver(s) 320 (e.g., cellular-only, etc.), or may omit the satellite signal interface 330, or may omit the sensor(s) 344, and so on. In another example, in case of FIG. 3B, a particular implementation of the base station 304 may omit the WWAN transceiver(s) 350 (e.g., a Wi-Fi “hotspot” access point without cellular capability), or may omit the short-range wireless transceiver(s) 360 (e.g., cellular-only, etc.), or may omit the satellite signal interface 370, and so on. For brevity, illustration of the various alternative configurations is not provided herein, but would be readily understandable to one skilled in the art.

The various components of the UE 302, the base station 304, and the network entity 306 may be communicatively coupled to each other over data buses 308, 382, and 392, respectively. In some aspects, the data buses 308, 382, and 392 may form, or be part of, a communication interface of the UE 302, the base station 304, and the network entity 306, respectively. For example, where different logical entities are embodied in the same device (e.g., gNB and location server functionality incorporated into the same base station 304), the data buses 308, 382, and 392 may provide communication between them.

The components of FIGS. 3A, 3B, and 3C may be implemented in various ways. In some implementations, the components of FIGS. 3A, 3B, and 3C may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 310 to 346 may be implemented by processor and memory component(s) of the UE 302 (e.g., by execution of appropriate code and/or by appropriate configuration of processor components). Similarly, some or all of the functionality represented by blocks 350 to 388 may be implemented by processor and memory component(s) of the base station 304 (e.g., by execution of appropriate code and/or by appropriate configuration of processor components). Also, some or all of the functionality represented by blocks 390 to 398 may be implemented by processor and memory component(s) of the network entity 306 (e.g., by execution of appropriate code and/or by appropriate configuration of processor components). For simplicity, various operations, acts, and/or functions are described herein as being performed “by a UE,” “by a base station,” “by a network entity,” etc. However, as will be appreciated, such operations, acts, and/or functions may actually be performed by specific components or combinations of components of the UE 302, base station 304, network entity 306, etc., such as the processors 342, 384, 394, the transceivers 310, 320, 350, and 360, the memories 340, 386, and 396, the positioning/sensing component 348, 388, and 398, etc.

In some designs, the network entity 306 may be implemented as a core network component. In other designs, the network entity 306 may be distinct from a network operator or operation of the cellular network infrastructure (e.g., NG RAN 220 and/or 5GC 210/260). For example, the network entity 306 may be a component of a private network that may be configured to communicate with the UE 302 via the base station 304 or independently from the base station 304 (e.g., over a non-cellular communication link, such as Wi-Fi).

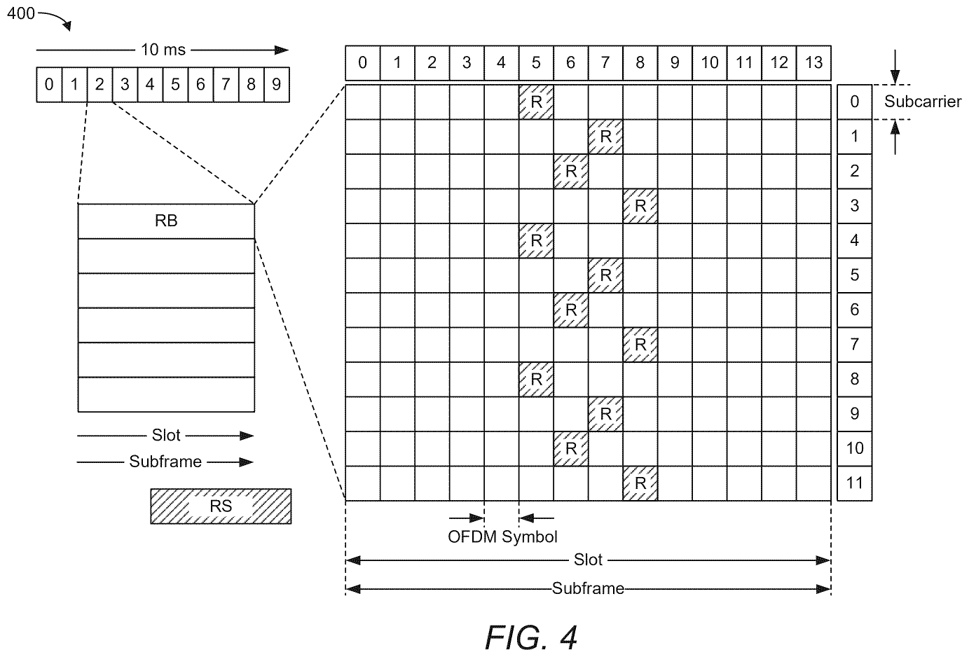

Various frame structures may be used to support downlink and uplink transmissions between network nodes (e.g., base stations and UEs). FIG. 4 is a diagram 400 illustrating an example frame structure, according to aspects of the disclosure. The frame structure may be a downlink or uplink frame structure. Other wireless communications technologies may have different frame structures and/or different channels.

LTE, and in some cases NR, utilizes orthogonal frequency-division multiplexing (OFDM) on the downlink and single-carrier frequency division multiplexing (SC-FDM) on the uplink. Unlike LTE, however, NR has an option to use OFDM on the uplink as well. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kilohertz (kHz) and the minimum resource allocation (resource block) may be 12 subcarriers (or 180 kHz). Consequently, the nominal fast Fourier transform (FFT) size may be equal to 128, 256, 512, 1024, or 2048 for system bandwidth of 1.25, 2.5, 5, 10, or 20 megahertz (MHz), respectively. The system bandwidth may also be partitioned into subbands. For example, a subband may cover 1.08 MHz (i.e., 6 resource blocks), and there may be 1, 2, 4, 8, or 16 subbands for system bandwidth of 1.25, 2.5, 5, 10, or 20 MHz, respectively.

LTE supports a single numerology (subcarrier spacing (SCS), symbol length, etc.). In contrast, NR may support multiple numerologies (μ), for example, subcarrier spacings of 15 kHz (μ=0), 30 kHz (μ=1), 60 kHz (μ=2), 120 kHz (μ=3), and 240 kHz (μ=4) or greater may be available. In each subcarrier spacing, there are 14 symbols per slot. For 15 kHz SCS (μ=0), there is one slot per subframe, 10 slots per frame, the slot duration is 1 millisecond (ms), the symbol duration is 66.7 microseconds (μs), and the maximum nominal system bandwidth (in MHz) with a 4K FFT size is 50. For 30 kHz SCS (μ=1), there are two slots per subframe, 20 slots per frame, the slot duration is 0.5 ms, the symbol duration is 33.3 μs, and the maximum nominal system bandwidth (in MHz) with a 4K FFT size is 100. For 60 kHz SCS (μ=2), there are four slots per subframe, 40 slots per frame, the slot duration is 0.25 ms, the symbol duration is 16.7 μs, and the maximum nominal system bandwidth (in MHz) with a 4K FFT size is 200. For 120 kHz SCS (μ=3), there are eight slots per subframe, 80 slots per frame, the slot duration is 0.125 ms, the symbol duration is 8.33 μs, and the maximum nominal system bandwidth (in MHz) with a 4K FFT size is 400. For 240 kHz SCS (μ=4), there are 16 slots per subframe, 160 slots per frame, the slot duration is 0.0625 ms, the symbol duration is 4.17 μs, and the maximum nominal system bandwidth (in MHz) with a 4K FFT size is 800.

In the example of FIG. 4, a numerology of 15 kHz is used. Thus, in the time domain, a 10 ms frame is divided into 10 equally sized subframes of 1 ms each, and each subframe includes one time slot. In FIG. 4, time is represented horizontally (on the X axis) with time increasing from left to right, while frequency is represented vertically (on the Y axis) with frequency increasing (or decreasing) from bottom to top.

A resource grid may be used to represent time slots, each time slot including one or more time-concurrent resource blocks (RBs) (also referred to as physical RBs (PRBs)) in the frequency domain. The resource grid is further divided into multiple resource elements (REs). An RE may correspond to one symbol length in the time domain and one subcarrier in the frequency domain. In the numerology of FIG. 4, for a normal cyclic prefix, an RB may contain 12 consecutive subcarriers in the frequency domain and seven consecutive symbols in the time domain, for a total of 84 REs. For an extended cyclic prefix, an RB may contain 12 consecutive subcarriers in the frequency domain and six consecutive symbols in the time domain, for a total of 72 REs. The number of bits carried by each RE depends on the modulation scheme.

Some of the REs may carry reference (pilot) signals (RS). The reference signals may include positioning reference signals (PRS), tracking reference signals (TRS), phase tracking reference signals (PTRS), cell-specific reference signals (CRS), channel state information reference signals (CSI-RS), demodulation reference signals (DMRS), primary synchronization signals (PSS), secondary synchronization signals (SSS), synchronization signal blocks (SSBs), sounding reference signals (SRS), etc., depending on whether the illustrated frame structure is used for uplink or downlink communication. FIG. 4 illustrates example locations of REs carrying a reference signal (labeled “R”).

An over-the-top (OTT) server (a third-party server external to an operator's cellular network) may perform positioning operations with one or more UEs, much like a location server (e.g., LMF 270), but without coordinating with a location server or any base stations to configure specific reference signal transmissions for the UE(s) to measure. Rather, the OTT server and UE(s) utilize reference signals already transmitted in cellular networks (e.g., 5G and/or LTE networks). This type of positioning, without coordination with a location server or base station, but rather, utilizing reference signals that are already scheduled to be transmitted to and measured by a connected UE, is referred to as “OTT-based positioning,” “OTT positioning,” and the like. The reference signals measured by the UE are referred to as “OTT reference signals,” “OTT signals,” and the like.

For example, TRS may be used for positioning purposes, such as OTT-based positioning. TRS are configured in each cell with their own time, frequency, and scrambling identifier. It is mandatory for all UEs to support TRS reception, and all 5G networks are required to transmit TRS. However, a UE is only aware of the TRS configuration of its serving cell. In addition, the TRS in one cell may collide with data, TRS, or CSI-RS in neighboring cells.

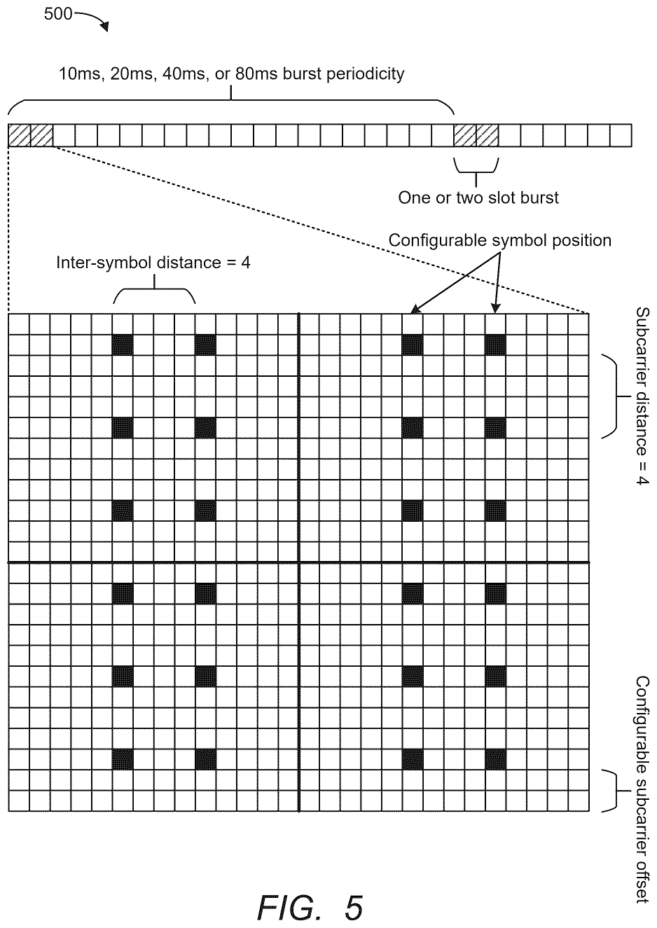

FIG. 5 is a diagram 500 illustrating an example TRS configuration, according to aspects of the disclosure. In FIG. 5, time is represented horizontally (on the X axis) with time increasing from left to right, while frequency is represented vertically (on the Y axis) with frequency increasing (or decreasing) from bottom to top. In the example of FIG. 5, two sequential slots are expanded to show the resource elements of four resource blocks making up the two slots.

As shown in FIG. 5, TRS are transmitted in a burst of one or two slots with a periodicity of 10 ms, 20 ms, 40 ms, or 80 ms. Within a slot, the positions of the symbols carrying the TRS are configurable, provided there is a four-symbol inter-symbol distance between the TRS symbols. For FR1, the permitted symbol pair positions are (4, 8), (5, 9), and (6, 10). For FR2, all symbol pair positions within one slot are allowed. In the frequency domain, there is a fixed subcarrier distance between TRS subcarriers of four subcarriers. There is also a configurable subcarrier offset within each resource block. The TRS bandwidth may be equal to the device's downlink bandwidth part (DL-BWP) (i.e., as large as 272 PRBs) or 48 PRBs.

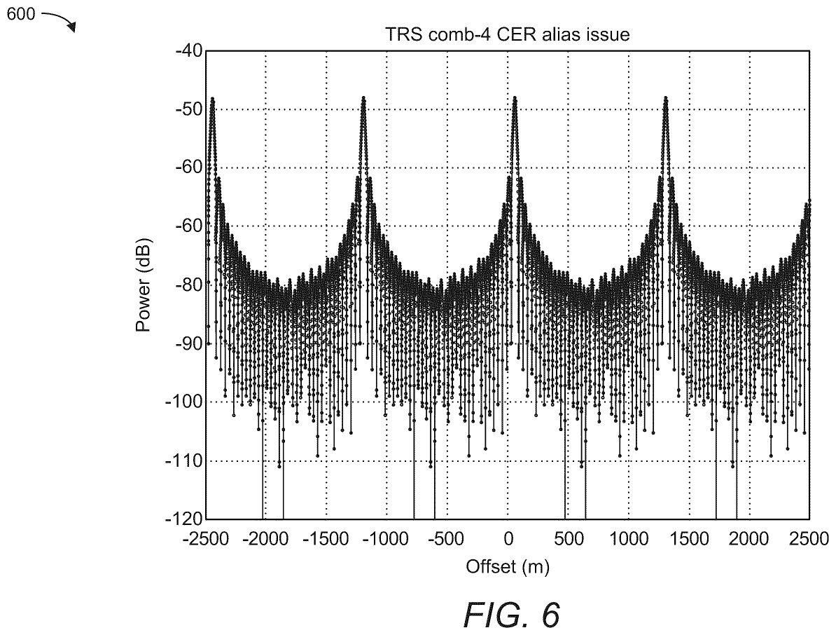

As shown in FIG. 5, TRS are not fully staggered in the frequency domain (TRS are transmitted with a comb-4 comb pattern), and therefore, four peaks are expected to be observed in the channel estimate (e.g., channel energy response (CER)) of the TRS. More specifically, because TRS are transmitted on a given symbol with gaps in the frequency domain, it results in aliasing of the channel estimate. Aliasing is a result of converting the frequency domain to the time domain when estimating the channel estimate, and appears as multiple equally sized peaks, as shown in FIG. 6. Specifically, FIG. 6 is a graph 600 of a CER estimate for a single symbol where the measured TRS is transmitted using a comb-4 pattern. As shown in FIG. 6, the CER has four significant peaks, due to the TRS being transmitted with a comb-4 pattern (i.e., on every fourth subcarrier), but only one of these peaks is the “true” peak (i.e., represents the actual time of arrival (ToA) of the TRS in that symbol). However, because the TRS in a cell is quasi-co-located with the SSB in the cell, the SSB can also be measured to solve the time-domain aliasing problem of the TRS in that cell.

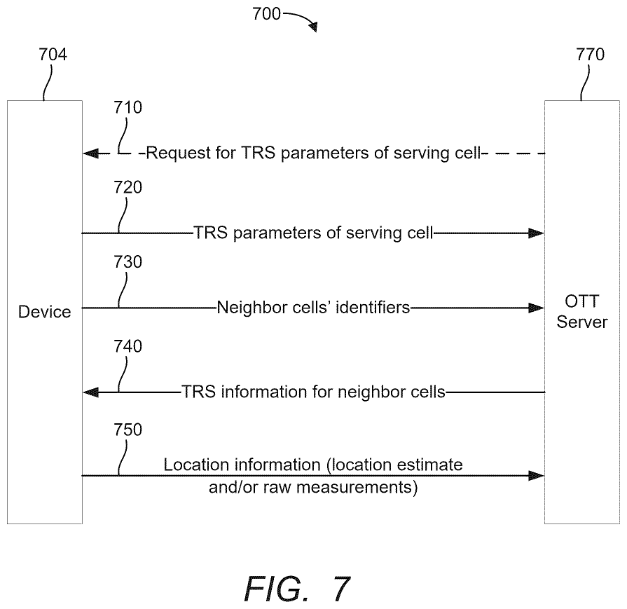

FIG. 7 illustrates an example OTT-based positioning procedure 700 using TRS, according to aspects of the disclosure. The OTT-based positioning procedure 700 may be performed between a client device 704 (e.g., a mobile device, an IoT device, or any other type of UE) and an OTT server 770 (e.g., a third-party server, a connected intelligent edge (CIE) server, etc.).

At stage 710, the OTT server 770 optionally sends a request to a client device 704 to report TRS configuration parameters (e.g., symbol pattern, symbol offset, frequency offset, number of slots per burst, burst periodicity, scrambling identifier, QCL relation, PCI, etc.) for the device's 704 serving cell. The request may configure the device 704 to report the TRS configuration parameter periodically or when any change is determined. The request may also configure the device 704 to report only the TRS configuration for a subset of TRS detected by the device 704 based on certain criteria. For example, the request may configure the device 704 to only report the TRS configuration(s) for TRS having a signal strength above a threshold. The request may also configure the device 704 to only report TRS configurations associated to a specific component carrier, frequency band, or frequency range (e.g., FR1 and/or FR2). Further, the request may configure the device 704 to transition to an RRC connected state for the purpose of gathering the TRS configuration parameters from the network.

At stage 720, the device 704 reports the requested TRS configuration parameters to the OTT server 770. Note that the device 704 may automatically report the TRS parameters of its serving cell without receiving a request from the OTT server 770 at stage 710, such as when changing serving cells or on a periodic basis.

At stage 730, the device 704 reports the identifiers (e.g., PCIs) of any neighbor cells that it discovered through, for example, radio resource management (RRM) procedures. The device 704 may also send RSRP, RSRQ, SINR, and/or received signal strength indication (RSSI) measurements associated with the PCIs of the neighbor cells. The report may include component carrier(s), frequency band(s), frequency range(s), slot offset(s), periodicity(ies), subframe-offset(s), time window(s), and/or preferred TRS configurations to be provided by the OTT server 770 (if available). These parameters can be reported in priority order.

Note that stages 720 and 730 may be a single transmission sequence or multiple transmission sequences. For example, the device 704 may transmit, and the OTT server 770 receive, both the serving cell information (e.g., the requested TRS configuration parameters) and the neighbor cell information (e.g., the identifiers of any neighbor cells) in the same data transmission (i.e., stages 720 and 730 are a single transmission sequence), or the device 704 may first transmit, and the OTT server 770 may first receive, the serving cell information and then the neighbor cell information (i.e., stages 720 and 730 are separate transmissions).

At stage 740, based on the identifiers of the neighbor cells, the OTT server 770 provides the TRS configuration for the identified neighbor cells to the device 704. The response may include one or more TRS configurations associated with a specific PCI and/or associated with SSBs from that PCI. The multiple TRS configurations may be “alternatives” for the device 704 to attempt to detect. The response may also include timestamps, validity timers, expiration timers, or the like indicating when the provided configurations are valid.

In some aspects, the OTT server 770 may have obtained the TRS information for the neighbor cells based on performing stages 710 and 720 with multiple other devices, thereby creating a crowdsourced database of the TRS parameters of multiple cells. In some cases, where the OTT server 770 does not have the TRS information for a neighbor cell indicated at stage 740, it can send a request, as at stage 710, to another device 704 that is known to have that neighbor cell as its serving cell. The OTT server 770 can thereby obtain the TRS configuration parameters for that cell from the other device 704, as at stage 720.

At stage 750, the device 704 reports location information to the OTT server 770. For UE-based positioning, the location information may be the device's 704 estimated location as determined from measurements of the TRS transmitted by the serving cell and the neighbor cells for which it received the TRS configuration information. Alternatively, or additionally, the location information may be the raw measurements of the TRS and the timestamps at which those measurements were obtained (as for UE-assisted positioning). The device 704 may also report which TRS were successfully detected, or which were not detected. That is, the device 704 may report the identifiers of the neighbor cells in which it detected or failed to detect the indicated TRS.

As will be appreciated, while the foregoing has described using TRS for positioning, the OTT-based positioning procedure 700 may instead be performed using CSI-RS or any other downlink reference signal specific to a serving cell.

After a random access procedure, the UE is in an RRC CONNECTED state. The RRC protocol is used on the air interface between a UE and a base station. The major functions of the RRC protocol include connection establishment and release functions, broadcast of system information, radio bearer establishment, reconfiguration, and release, RRC connection mobility procedures, paging notification and release, and outer loop power control. In LTE, a UE may be in one of two RRC states (CONNECTED or IDLE), but in NR, a UE may be in one of three RRC states (CONNECTED, IDLE, or INACTIVE). The different RRC states have different radio resources associated with them that the UE can use when it is in a given state. Note that the different RRC states are often capitalized, as above; however, this is not necessary, and these states can also be written in lowercase.

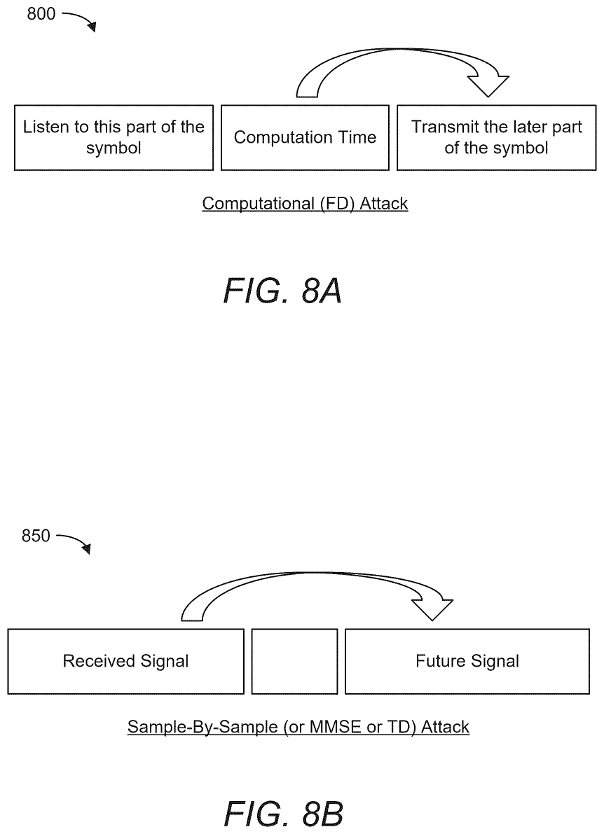

NR supports a number of cellular network-based positioning technologies, including downlink-based, uplink-based, and downlink-and-uplink-based positioning methods. Downlink-based positioning methods include observed time difference of arrival (OTDOA) in LTE, downlink time difference of arrival (DL-TDOA) in NR, and downlink angle-of-departure (DL-AoD) in NR. FIG. 8 illustrates examples of various positioning methods, according to aspects of the disclosure. In an OTDOA or DL-TDOA positioning procedure, illustrated by scenario 810, a UE measures the differences between the times of arrival (ToAs) of reference signals (e.g., positioning reference signals (PRS)) received from pairs of base stations, referred to as reference signal time difference (RSTD) or time difference of arrival (TDOA) measurements, and reports them to a positioning entity. More specifically, the UE receives the identifiers (IDs) of a reference base station (e.g., a serving base station) and multiple non-reference base stations in assistance data. The UE then measures the RSTD between the reference base station and each of the non-reference base stations. Based on the known locations of the involved base stations and the RSTD measurements, the positioning entity (e.g., the UE for UE-based positioning or a location server for UE-assisted positioning) can estimate the UE's location.

For DL-AoD positioning, illustrated by scenario 820, the positioning entity uses a measurement report from the UE of received signal strength measurements of multiple downlink transmit beams to determine the angle(s) between the UE and the transmitting base station(s). The positioning entity can then estimate the location of the UE based on the determined angle(s) and the known location(s) of the transmitting base station(s).

Uplink-based positioning methods include uplink time difference of arrival (UL-TDOA) and uplink angle-of-arrival (UL-AoA). UL-TDOA is similar to DL-TDOA, but is based on uplink reference signals (e.g., sounding reference signals (SRS)) transmitted by the UE to multiple base stations. Specifically, a UE transmits one or more uplink reference signals that are measured by a reference base station and a plurality of non-reference base stations. Each base station then reports the reception time (referred to as the relative time of arrival (RTOA)) of the reference signal(s) to a positioning entity (e.g., a location server) that knows the locations and relative timing of the involved base stations. Based on the reception-to-reception (Rx-Rx) time difference between the reported RTOA of the reference base station and the reported RTOA of each non-reference base station, the known locations of the base stations, and their known timing offsets, the positioning entity can estimate the location of the UE using TDOA.

For UL-AoA positioning, one or more base stations measure the received signal strength of one or more uplink reference signals (e.g., SRS) received from a UE on one or more uplink receive beams. The positioning entity uses the signal strength measurements and the angle(s) of the receive beam(s) to determine the angle(s) between the UE and the base station(s). Based on the determined angle(s) and the known location(s) of the base station(s), the positioning entity can then estimate the location of the UE.

Downlink-and-uplink-based positioning methods include enhanced cell-ID (E-CID) positioning and multi-round-trip-time (RTT) positioning (also referred to as “multi-cell RTT” and “multi-RTT”). In an RTT procedure, a first entity (e.g., a base station or a UE) transmits a first RTT-related signal (e.g., a PRS or SRS) to a second entity (e.g., a UE or base station), which transmits a second RTT-related signal (e.g., an SRS or PRS) back to the first entity. Each entity measures the time difference between the time of arrival (ToA) of the received RTT-related signal and the transmission time of the transmitted RTT-related signal. This time difference is referred to as a reception-to-transmission (Rx-Tx) time difference. The Rx-Tx time difference measurement may be made, or may be adjusted, to include only a time difference between nearest slot boundaries for the received and transmitted signals. Both entities may then send their Rx-Tx time difference measurement to a location server (e.g., an LMF 270), which calculates the round trip propagation time (i.e., RTT) between the two entities from the two Rx-Tx time difference measurements (e.g., as the sum of the two Rx-Tx time difference measurements). Alternatively, one entity may send its Rx-Tx time difference measurement to the other entity, which then calculates the RTT. The distance between the two entities can be determined from the RTT and the known signal speed (e.g., the speed of light). For multi-RTT positioning, illustrated by scenario 830, a first entity (e.g., a UE or base station) performs an RTT positioning procedure with multiple second entities (e.g., multiple base stations or UEs) to enable the location of the first entity to be determined (e.g., using multilateration) based on distances to, and the known locations of, the second entities. RTT and multi-RTT methods can be combined with other positioning techniques, such as UL-AoA and DL-AoD, to improve location accuracy, as illustrated by scenario 840.

The E-CID positioning method is based on radio resource management (RRM) measurements. In E-CID, the UE reports the serving cell ID, the timing advance (TA), and the identifiers, estimated timing, and signal strength of detected neighbor base stations. The location of the UE is then estimated based on this information and the known locations of the base station(s).

To assist positioning operations, a location server (e.g., location server 230, LMF 270, SLP 272) may provide assistance data to the UE. For example, the assistance data may include identifiers of the base stations (or the cells/TRPs of the base stations) from which to measure reference signals, the reference signal configuration parameters (e.g., the number of consecutive slots including PRS, periodicity of the consecutive slots including PRS, muting sequence, frequency hopping sequence, reference signal identifier, reference signal bandwidth, etc.), and/or other parameters applicable to the particular positioning method. Alternatively, the assistance data may originate directly from the base stations themselves (e.g., in periodically broadcasted overhead messages, etc.). In some cases, the UE may be able to detect neighbor network nodes itself without the use of assistance data.

In the case of an OTDOA or DL-TDOA positioning procedure, the assistance data may further include an expected RSTD value and an associated uncertainty, or search window, around the expected RSTD. In some cases, the value range of the expected RSTD may be +/−500 microseconds (μs). In some cases, when any of the resources used for the positioning measurement are in FR1, the value range for the uncertainty of the expected RSTD may be +/−32 μs. In other cases, when all of the resources used for the positioning measurement(s) are in FR2, the value range for the uncertainty of the expected RSTD may be +/−8 μs.

A location estimate may be referred to by other names, such as a position estimate, location, position, position fix, fix, or the like. A location estimate may be geodetic and comprise coordinates (e.g., latitude, longitude, and possibly altitude) or may be civic and comprise a street address, postal address, or some other verbal description of a location.

A location estimate may further be defined relative to some other known location or defined in absolute terms (e.g., using latitude, longitude, and possibly altitude). A location estimate may include an expected error or uncertainty (e.g., by including an area or volume within which the location is expected to be included with some specified or default level of confidence).

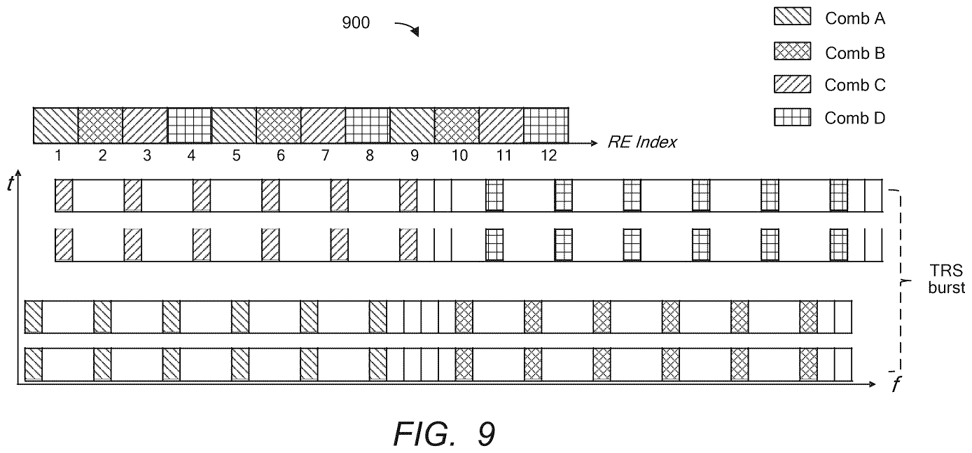

FIG. 9 illustrates an example location services procedure 900, according to aspects of the disclosure. The location services procedure 900 may be performed by a UE 204, an NG-RAN node 902 (e.g., gNB 222, gNB-CU 226, ng-eNB 224, or other node in the NG-RAN 220) in the NG-RAN 220, an AMF 264, an LMF 270, and a 5GC location services (LCS) entity 980 (e.g., any third-party application requesting the UE's 204 location, a public service access point (PSAP), an E-911 server, etc.).

A location services request to obtain the location of a target (i.e., UE 204) may be initiated by a 5GC LCS entity 980, the AMF 264 serving the UE 204, or the UE 204 itself. FIG. 9 illustrates these options as stages 910a, 910b, and 910c, respectively. Specifically, at stage 910a, a 5GC LCS entity 980 sends a location services request to the AMF 264. Alternatively, at stage 910b, the AMF 264 generates a location services request itself. Alternatively, at stage 910c, the UE 204 sends a location services request to the AMF 264.

Once the AMF 264 has received (or generated) a location services request, it forwards the location services request to the LMF 270 at stage 920. The LMF 270 then performs NG-RAN positioning procedures with the NG-RAN node 902 at stage 930a and UE positioning procedures with the UE 204 at stage 930b. The specific NG-RAN positioning procedures and UE positioning procedures may depend on the type(s) of positioning method(s) used to locate the UE 204, which may depend on the capabilities of the UE 204. The positioning method(s) may be downlink-based (e.g., LTE observed time difference of arrival (OTDOA), downlink time difference of arrival (DL-TDOA), downlink angle of departure (DL-AoD), etc.), uplink-based (e.g., uplink time difference of arrival (UL-TDOA), uplink angle of arrival (UL-AoA), etc.), and/or downlink-and-uplink-based (e.g., LTE/NR E-CID, multi-round trip time (multi-RTT), etc.).

The NG-RAN positioning procedures and UE positioning procedures may utilize LTE positioning protocol (LPP) signaling between the UE 204 and the LMF 270 and LPP type A (LPPa) or New Radio positioning protocol type A (NRPPa) signaling between the NG-RAN node 902 and the LMF 270. LPP is used point-to-point between a location server (e.g., LMF 270) and a UE (e.g., UE 204) in order to obtain location-related measurements or a location estimate or to transfer assistance data. A single LPP session is used to support a single location request (e.g., for a single mobile-terminated location request (MT-LR), mobile-originated location request (MO-LR), or network induced location request (NI-LR)). Multiple LPP sessions can be used between the same endpoints to support multiple different location requests. Each LPP session comprises one or more LPP transactions, with each LPP transaction performing a single operation (e.g., capability exchange, assistance data transfer, location information transfer). LPP transactions are referred to as LPP procedures.

A prerequisite for stage 930 is that an LCS Correlation identifier (ID) and an AMF ID has been passed to the LMF 270 by the serving AMF 264. Both, the LCS Correlation ID and the AMF ID may be represented as a string of characters selected by the AMF 264. The LCS Correlation ID and the AMF ID are provided by the AMF 264 to the LMF 270 in the location services request at stage 920. When the LMF 270 then instigates stage 930, the LMF 270 also includes the LCS Correlation ID for this location session, together with the AMF ID, which indicates the AMF instance serving the UE 204. The LCS Correlation ID is used to ensure that during a positioning session between the LMF 270 and the UE 204, positioning response messages from the UE 204 are returned by the AMF 264 to the correct LMF 270 and carrying an indication (the LCS Correlation ID) that can be recognized by the LMF 270.

Note that the LCS Correlation ID serves as a location session identifier that may be used to identify messages exchanged between the AMF 264 and the LMF 270 for a particular location session for a UE 204, as described in greater detail in 3GPP Technical Specification (TS) 23.273. As mentioned above and shown in stage 920, a location session between an AMF 264 and an LMF 270 for a particular UE 204 is instigated by the AMF 264, and the LCS Correlation ID may be used to identify this location session (e.g., may be used by the AMF 264 to identify state information for this location session, etc.).

LPP signaling can be used to request and report measurements related to the following positioning methods: LTE-OTDOA, DL-TDOA, assisted global navigation satellite system (A-GNSS), E-CID, sensor, terrestrial beacon system (TBS), WLAN, BLUETOOTH®, DL-AOD, UL-AoA, and multi-RTT. Currently, LPP measurement reports may contain the following measurements: (1) one or more time of arrival (ToA), TDOA, reference signal time difference (RSTD), or reception-to-transmission (Rx-Tx) time difference measurements, (2) one or more AoA and/or AoD measurements (currently only for a base station to report UL-AoA and DL-AoD to the LMF 270), (3) one or more multipath measurements (per-path ToA, RSRP, AoA/AOD), (4) one or more motion states (e.g., walking, driving, etc.) and trajectories (currently only for the UE 204), and (5) one or more report quality indications.

As part of the NG-RAN node positioning procedures (stage 930a) and UE positioning procedures (stage 930b), the LMF 270 may provide LPP assistance data in the form of downlink positioning reference signal (DL-PRS) configuration information to the NG-RAN node 902 and the UE 204 for the selected positioning method(s). Alternatively or additionally, the NG-RAN node 902 may provide DL-PRS and/or uplink PRS (UL-PRS) configuration information to the UE 204 for the selected positioning method(s). Note that while FIG. 9 illustrates a single NG-RAN node 902, there may be multiple NG-RAN nodes 902 involved in the positioning session.

Once configured with the DL-PRS and/or UL-PRS configurations, the NG-RAN node 902 and the UE 204 transmit and receive/measure the respective PRS at the scheduled times. The NG-RAN node 902 and the UE 204 then send their respective measurements to the LMF 270. In some cases, the NG-RAN node 902 may send its measurements to the UE 204, which may forward them to the LMF 270 using LPP signaling. Alternatively, the NG-RAN node 902 may send its measurements directly to the LMF 270 in LPPa or NRPPa signaling. In some cases, the UE 204 may send its measurements to the NG-RAN node 902 in RRC, uplink control information (UCI), or MAC control element (MAC-CE) signaling, and the NG-RAN node 902 may forward the measurements to the LMF 270 using LPPa or NRPPa signaling. Alternatively, the UE 204 may send its measurements directly to the LMF 270 using LPP signaling.

Once the LMF 270 obtains the measurements from the UE 204 and/or the NG-RAN node 902 (depending on the type(s) of positioning method(s)), it calculates an estimate of the UE's 204 location using those measurements. Then, at stage 940, the LMF 270 sends a location services response, which includes the location estimate for the UE 204, to the AMF 264. The AMF 264 then forwards the location services response to the entity that generated the location services request at stage 950. Specifically, if the location services request was received from a 5GC LCS entity 980 at stage 910a, then at stage 950a, the AMF 264 sends a location services response to the 5GC LCS entity 980. If, however, the location services request was received from the UE 204 at stage 910c, then at stage 950c, the AMF 264 sends a location services response to the UE 204. Or, if the AMF 264 generated the location services request at stage 910b, then at stage 950b, the AMF 264 stores/uses the location services response itself.

Note that although the foregoing has described the location services procedure 900 as a UE-assisted location services procedure, it may instead be a UE-based location services procedure. A UE-assisted location services procedure is one where the LMF 270 calculates the location of the UE 204, whereas a UE-based location services procedure is one where the UE 204 calculates its own location. In the case of a UE-based location services procedure, stages 910c and 950c would be performed. The LMF 270 may still coordinate the transmission/measurement of DL-PRS (and possibly UL-PRS), but the measurements would be forwarded to the UE 204 rather than the LMF 270. As such, the location services response at stages 940 and 950c may be the measurements from the involved NG-RAN node(s) 902 rather than a location estimate of the UE 204.

Alternatively, where the involved NG-RAN node(s) 902 forward their respective measurements directly to the UE 204 (e.g., via RRC signaling), the location services response at stage 940 may simply be a confirmation that the NG-RAN node and UE positioning procedures at stage 930 are complete.

Some types of OTT signaling, such as 4G LTE CRS and 5G NR TRS, have been proposed for cellular-based UE positioning operations. In 6G communication networks, wideband communications reference signals (e.g., TRS) may be used for non-communication operations (also called “vertical” use cases), such as UE positioning and/or sensing operations, due to the large bandwidth and performance provided by such reference signals. In addition to performance, the security aspect of UE positioning and/or sensing may provide additional benefits for commercial deployment.

The following table illustrates examples of different types of man-in-the-middle attacks.

TABLE 1

| Name | Description |
|---|---|
| Cyclic Prefix Attack | The attacker listens to the cyclic prefix (CP) at the |
| | beginning of one PRS symbol and transmits a |
| | copy of the CP in a subsequent symbol |
| Noise Attack (Jamming) | The man-in-the-middle transmits noise. |
| | Sometimes this will produce a channel estimate |
| | with an artificially earlier path |
| Computational (Frequency | The attacker listens to the initial part of the PRS, |
| Domain (FD)) Attack | decodes it, and then sends an attack in the second |
| | part of the PRS |
| Sample-by-Sample (or | The attacker listens to a portion of the symbol |
| Minimum Mean Square | and then predicts the next few samples. |
| Error (MMSE) or Time | Bandlimited waveform results in autocorrelation |
| Domain (TD)) Attack | between samples |

FIGS. 8A and 8B illustrate two types of man-in-the-middle attacks in which an attacker observes the first part of a PRS and transmits during a second part of the PRS, according to aspects of the disclosure. Specifically, FIG. 9A is a diagram 800 illustrating a computational attack, also referred to as a frequency domain (FD) attack. As shown in FIG. 8A, at a high level, during the first portion of the PRS, the attacker “listens” to the waveform (e.g., PRS) and decodes it (shown as “computation time”). Specifically, the attacker determines which QAM symbols have been sent, and then the scrambling ID. There are across-symbol attackers and within-symbol attackers. An across-symbol attacker receives a set of PRS symbols, performs blind detection of which scrambling ID was used, and then transmits the remaining PRS symbols with some timing advance (i.e., sooner than the actual transmitter would transmit the remaining PRS symbols). A within-symbol attacker is able to receive a part of a single OFDM symbol, perform the frequency domain or time domain attack (computation or symbol-by-symbol attack) and transmit the remaining part of that single symbol with a timing advance.

FIG. 8B is a diagram 850 illustrating a sample-by-sample attack, also referred to as a minimum mean square error (MMSE) attack or time domain (TD) attack. As shown in FIG. 8B, during the first portion of a symbol, the attacker receives a first part of the PRS, determines the correlation (band-limited signal), and predicts a few samples into the future. For example, the attacker may use a Wiener filter to predict the future signal by exploiting the correlation between the signal previously received and the future signal unreceived. The attacker then transmits the predicted samples.

In some implementations, a pseudo-random QPSK sequence that changes per OFDM symbol per slot and a scrambling ID per TRS resource may be provided. In some implementations, the number of NR TRS scrambling IDs (e.g., 1024) may be smaller than the number of NR PRS scrambling IDs (e.g., 4096). According to aspects of the disclosure, a TRS sequence may be generated with a different scrambling ID per symbol to avoid across-symbol attacks. A distinct scrambling ID may be generated for each symbol, and there is no correlation between scrambling IDs across the OFDM symbols. For example, a different scrambling ID may be generated for each of the OFDM symbols as shown in FIG. 5 without correlation between different scrambling IDs for different OFDM symbols. The scrambling ID for each of the OFDM symbols may be generated randomly to avoid a correlation between different scrambling IDs. In some aspects, there is no correlation between initial seeds of OFDM symbols to further reduce the probability of across-symbol attacks. If there are multiple TRSs configured at the same symbol, the scrambling IDs for these multiple TRSs are uncorrelated with one another.

In some aspects, a two-stage TRS resource configuration and signaling process may be provided. At the first stage (“Stage 1”), a TRS resource configuration and signaling may include one or more general parameters for the TRS, including, for example, a time location, a frequency location, a periodicity, quasi co-location (QCL) information, etc. At the second stage (“Stage 2”), the TRS resource configuration and signaling may include scrambling ID related parameters. In some aspects, the scrambling ID related parameters may include distinct scrambling IDs that are uncorrelated with one another across a symbol sequence.

In some aspects, with Stage 1 signaling, a UE may buffer the symbols that may potentially carry a TRS resource, and then start processing the TRS resource after the values of the TRS parameters in Stage 1 are received.

In some aspects, with the two-stage TRS configuration and signaling that include a configuration of scrambling IDs, an attacker UE may not be able to carry out an attack successfully even if it receives the same configuration as a legitimate UE and even if it is able to determine blindly the scrambling ID of a first TRS symbol (or any one of the TRS symbols in the sequence). The attacker UE may not succeed in its attempted attack because there is no correlation between the scrambling ID detected by the attacker UE and the remaining scrambling IDs, and thus would not be able to generate the waveform of the remaining TRS symbols in order to attack the legitimate UE.

In some aspects, Stage 1 signaling may be RRC-based. For example, one or more general TRS parameters transmitted in Stage 1 may be transmitted as an RRC message. In some aspects, Stage 2 signaling may be medium access control-control element (MAC-CE) and/or downlink control information (DCI) based. For example, the scrambling ID related parameters transmitted in Stage 2 may be transmitted as a MAC-CE message or a DCI message.

In some aspects, mask-based security enhancement may be provided by precoding one or more TRS parameters. In some aspects, precoded TRS parameters may be obtained by dividing one or more TRS sub-bands or bandwidth parts (BWPs) into multiple PRB groups (PRGs) and applying precoding to the PRGs. For example, the sub-bands or BWPs may be divided into multiple PRGs (e.g., PRG(1), PRG(2), PRG(3), etc.), and closed loop or adaptive precoding may be applied to each of the PRGs. In some aspects, a precoding matrix may be signaled to the UE as part of the scrambling ID related parameters similar to Stage 2 signaling described above.

In some aspects, to further randomize the precoding of TRS parameters, the sizes of the PRGs may be configured as non-uniform. For example, each of the PRGs may have a different number of RBs. For example, a first PRG(PRG(1)) may have 4 RBs, a second PRG(PRG(2)) may have 6 RBs, and a third PRG(PRG(3)) may have 8 RBs.

In some aspects, to further randomize the precoding of TRS parameters, precoding cycling may be applied across multiple symbols of a TRS burst. In some aspects, the order of cycling in a TRS burst may be configured as a function of the UE ID, or signaled to the UE by RRC, MAC-CE, or DCI, for example.

In some aspects, dynamic comb offset based security enhancement may be provided for TRS bursts. In some aspects, within a TRS burst, the TRSs may be mapped to different combs in the frequency domain on the same symbol. In some aspects, the bandwidth of a TRS may be a multiple number of RBs and thus be partitioned into multiple blocks in the frequency domain.

FIG. 9 illustrates an example diagram 900 of partitioning of TRS blocks in a frequency domain and a time domain, according to aspects of the disclosure. In the example illustrated in FIG. 9, each distinct cross-hatch represents a different comb, which may be regarded as a frequency block in a resource element (RE) index. As illustrated in FIG. 9, a first set of blocks may be mapped to a first comb (denoted as “Comb A”), a second set of blocks may be mapped to a second comb (denoted as “Comb B”), a third set of blocks may be mapped to a third comb (denoted as “Comb C”), and a fourth set of blocks may be mapped to a fourth comb (denoted as “Comb D”).

In the example shown in FIG. 9, the third set of blocks mapped to Comb C may be offset from the first set of blocks mapped to Comb A in the frequency domain, while the fourth set of blocks mapped to Comb D may be offset from the second set of blocks mapped to Comb B in the frequency domain. In some aspects, the mapping of TRS blocks to combs may be different across different slots in a TRS burst to randomize the association of TRS blocks with the combs. In some aspects, the dynamic comb offset may be configured and signaled to the UE through RRC, MAC-CE, or DCI messaging, for example.

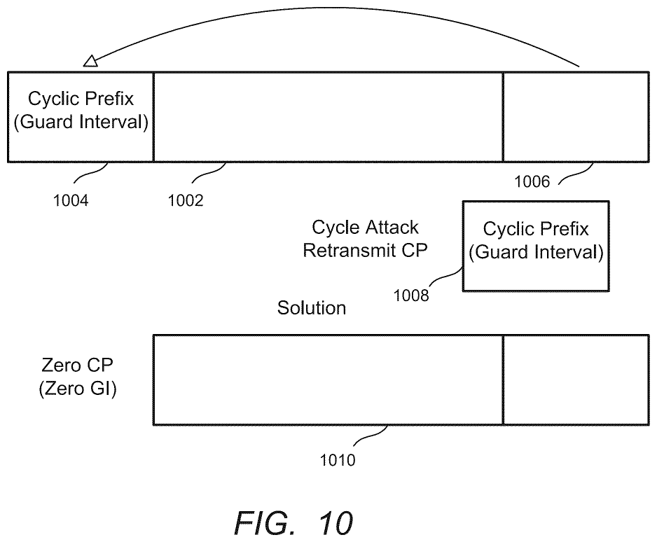

FIG. 10 illustrates an example of preventing a CP attack, according to aspects of the disclosure. In some aspects, CP attacks may be avoided by allocating zero CP for one or more TRS symbols. In the example shown in FIG. 10, a first TRS 1002 may be preceded by a first CP 1004, and a second CP 1006 may be transmitted after the first TRS 1002 for a second TRS (not shown) succeeding the first TRS 1002. In this configuration, a malefactor may attempt to monitor the first CP 1004 and initiate a CP attack by retransmitting that CP at or near the end of transmission of the first TRS 1002, as shown in block 1008.

In some aspects, CP attacks may be avoided by providing a TRS 1010 with zero CP (or zero GI). With zero CP (or zero GI), the malefactor may not have an opportunity to monitor a CP preceding the TRS 1010 because there is none. Although a zero-CP (or zero-GI) configuration may add some complexity to channel estimation in some implementations, channel estimation may still be achieved, and the zero-CP (or zero-GI) configuration may be an effective scheme for preventing a potential CP attack.

In some aspects, other schemes may be implemented to prevent or mitigate CP attacks. For example, a packet data protocol (PDP) comparison-based CP attack detection and reporting scheme may be used to prevent or mitigate CP attacks. In some aspects, the UE may compare a first PDP estimated by a TRS and a second PDP estimated by a nearby reference signal (RS) (e.g., a quasi co-location (QCL) demodulation reference signal (DMRS)) to identify whether there is a potential CP attack.

In some aspects, the UE may perform a PDP consistency check by comparing PDPs estimated by nearby RSs and report a potential CP attack to the network. In some aspects, the UE may autonomously drop or skip a positioning and/or sensing measurement operation based on a determination that a potential CP attack is present.

In some aspects, man-in-the-middle attacks may be avoided by the UE by utilizing its TRS buffering capability. In some aspects, the UE may be configured to report its capability of TRS buffering period to the network. The TRS buffering period is the length of time in which the UE is capable of buffering its partially processed TRS signals after a first TRS configuration and before a second TRS configuration.

Additionally or alternatively, the UE may be configured to report its capability of TRS buffering number to the network. The TRS buffering number is the number of partially processed TRS signals that the UE is capable of buffering in its storage after a first TRS configuration and before a second TRS configuration.

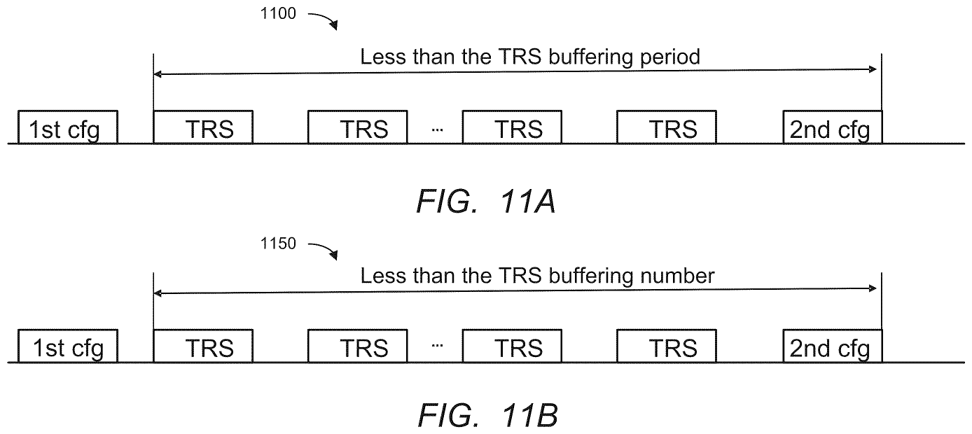

FIGS. 11A and 11B illustrate example diagrams 1100 and 1150 of TRS buffering period and TRS buffering number, respectively, according to aspects of the disclosure. FIG. 11A illustrates an example of TRS symbols after the first TRS configuration (denoted as “1st cfg”) and before the second TRS configuration (denoted as “2nd cfg”), where the number of TRS symbols between the first and second TRS configurations is less than the TRS buffering period for the UE. Similarly, FIG. 11B illustrates an example of TRS symbols after the first TRS configuration (denoted as “1st cfg”) and before the second TRS configuration (denoted as “2nd cfg”), where the number of TRS symbols between the first and second TRS configurations is less than the TRS buffering number for the UE. By utilizing its TRS buffering capability, the UE may drop or skip a positioning and/or sensing measurement operation based on a determination that a potential CP attack is present.

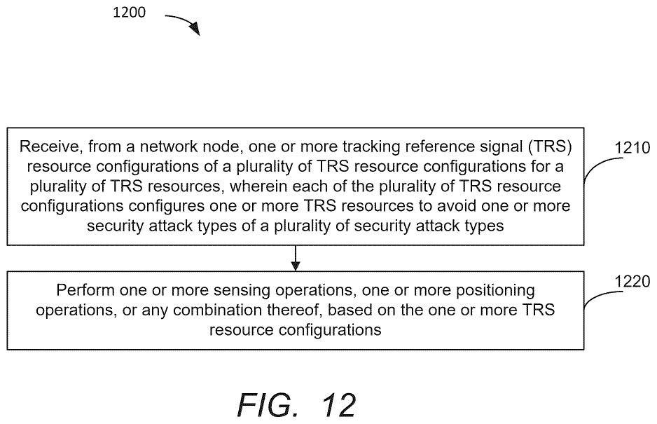

FIG. 12 illustrates an example method 1200 of wireless communication, according to aspects of the disclosure. In some aspects, method 1200 may be performed by a UE (e.g., UE 302 described herein).

At 1210, the UE may receive, from a network node, one or more tracking reference signal (TRS) resource configurations of a plurality of TRS resource configurations for a plurality of TRS resources, wherein each of the plurality of TRS resource configurations configures one or more TRS resources to avoid one or more security attack types of a plurality of security attack types.

Means for performing the operation of block 1210 may include the processor(s), memory, or transceiver(s) of any of the UE 302 described herein. For example, the operation of block 1210 may be performed by the one or more WWAN transceivers 310, the one or more short-range wireless transceivers 320, the one or more processors 342, memory 340, and/or positioning/sensing component 348, any or all of which may be considered means for performing this operation.

At 1220, the UE may perform one or more sensing operations, one or more positioning operations, or any combination thereof, based on the one or more TRS resource configurations.

Means for performing the operation of block 1220 may include the processor(s), memory, or transceiver(s) of any of the UE 302 described herein. For example, the operation of block 1220 may be performed by the one or more WWAN transceivers 310, the one or more short-range wireless transceivers 320, the one or more processors 342, memory 340, and/or positioning/sensing component 348, any or all of which may be considered means for performing this operation.

Method 1200 may include additional implementations, such as any single implementation or any combination of implementations described below and/or in connection with one or more other processes described elsewhere herein.

In some aspects, the plurality of security attack types comprise a cyclic prefix (CP) attack type, a noise or jamming attack type, a computational attack type, a frequency domain (FD) attack type, a sample-by-sample attack type, a minimum mean square error (MMSE) attack type, a time domain (TD) attack type, or any combination thereof.

In some aspects, the one or more TRS resource configurations comprise a configuration for a TRS sequence generated with a distinct scrambling identification (ID) per symbol.

In some aspects, method 1200 includes the distinct scrambling ID is a scrambling ID of a plurality of scrambling IDs, the symbol is a symbol of a plurality of symbols, and the plurality of scrambling IDs are not correlated to the plurality of symbols.

In some aspects, method 1200 includes the one or more TRS resource configurations comprise a configuration for a plurality of TRSs having a plurality of scrambling identifications (IDs) configured at a symbol, and the plurality of scrambling IDs are not correlated to each other.

In some aspects, the one or more TRS resource configurations comprise one or more configurations for a time location, a frequency location, a periodicity, quasi co-location (QCL) information, one or more scrambling identification (ID) parameters, or any combination thereof.

In some aspects, the one or more TRS resource configurations are transmitted as a radio resource control (RRC) message.

In some aspects, the one or more TRS resource configurations further comprise a configuration for one or more scrambling identification (ID) parameters.

In some aspects, the one or more scrambling ID parameters are transmitted as a medium access control-control element (MAC-CE) message or a downlink control information (DCI) message.

In some aspects, the one or more TRS resource configurations comprise a configuration for a plurality of precoded TRS parameters.

In some aspects, the plurality of precoded TRS parameters are obtained by dividing one or more sub-bands or bandwidth parts (BWPs) into a plurality of physical resource block groups (PRGs) and applying precoding to the plurality of PRGs to obtain the plurality of precoded TRS parameters.

In some aspects, the plurality of PRGs comprise at least a first PRG of a first size and a second PRG of a second size different from the first size.

In some aspects, the one or more TRS resource configurations comprise a configuration for a plurality of resource block (RB) combs offset from each other in a time domain and in a frequency domain.

In some aspects, the one or more TRS resource configurations comprise a configuration for a zero cyclic prefix (CP) for one or more of a plurality of TRS symbols.

In some aspects, the one or more TRS resource configurations comprise a configuration for the UE to avoid a sensing measurement, a positioning measurement, or both based on a comparison of a first packet data protocol (PDP) estimated by a TRS and a second PDP estimated by a nearby reference signal (RS) indicating a potential cyclic prefix (CP) attack.

In some aspects, the one or more TRS resource configurations comprise a configuration for a TRS buffering period or a TRS buffering number based on a number of partially processed TRSs capable of being buffered in a storage of the UE.

Although FIG. 12 shows example operations of method 1200, in some implementations, method 1200 may include additional operations, fewer operations, different operations, or differently arranged operations than those depicted in FIG. 12. Additionally, or alternatively, two or more of the operations of method 1200 may be performed in parallel, or performed in a sequence different from the sequence listed in FIG. 12.

As will be appreciated, a technical advantage of the method 1200 is that, by implementing one or more types of TRS resource configurations, including, for example, generating a TRS sequence with distinct and uncorrelated scrambling identifiers (IDs), the described techniques can be used to avoid various types of man-in-the-middle attacks.

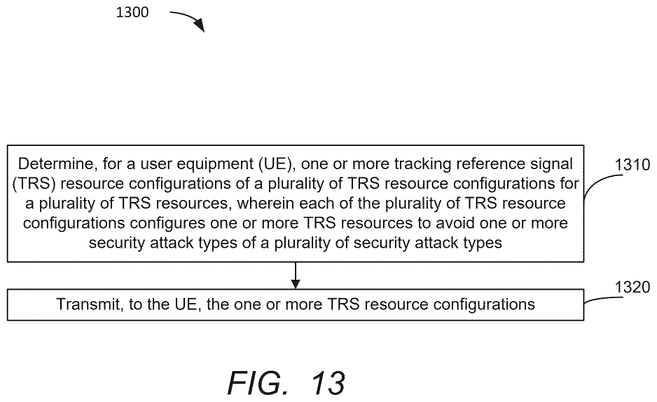

FIG. 13 illustrates an example method 1300 of wireless communication, according to aspects of the disclosure. In some aspects, method 1300 may be performed by a network node (e.g., base station 304 described herein).

At 1310, the network node may determine, for a user equipment (UE), one or more tracking reference signal (TRS) resource configurations of a plurality of TRS resource configurations for a plurality of TRS resources, wherein each of the plurality of TRS resource configurations configures one or more TRS resources to avoid one or more security attack types of a plurality of security attack types.

Means for performing the operation of block 1310 may include the processor(s), memory, or transceiver(s) of any of the base station 304 described herein. For example, the operation of block 1310 may be performed by the one or more WWAN transceivers 350, the one or more short-range wireless transceivers 360, the one or more processors 384, memory 386, and/or positioning/sensing component 388, any or all of which may be considered means for performing this operation.

At 1320, the network node may transmit, to the UE, the one or more TRS resource configurations.

Means for performing the operation of block 1320 may include the processor(s), memory, or transceiver(s) of any of the base station 304 described herein. For example, the operation of block 1320 may be performed by the one or more WWAN transceivers 350, the one or more short-range wireless transceivers 360, the one or more processors 384, memory 386, and/or positioning/sensing component 388, any or all of which may be considered means for performing this operation.

Method 1300 may include additional implementations, such as any single implementation or any combination of implementations described below and/or in connection with one or more other processes described elsewhere herein.

In some aspects, the plurality of security attack types comprise a cyclic prefix (CP) attack type, a noise or jamming attack type, a computational attack type, a frequency domain (FD) attack type, a sample-by-sample attack type, a minimum mean square error (MMSE) attack type, a time domain (TD) attack type, or any combination thereof.

In some aspects, the one or more TRS resource configurations comprise a configuration for a TRS sequence generated with a distinct scrambling identification (ID) per symbol.

In some aspects, method 1300 includes the distinct scrambling ID is a scrambling ID of a plurality of scrambling IDs, the symbol is a symbol of a plurality of symbols, and the plurality of scrambling IDs are not correlated to the plurality of symbols.

In some aspects, method 1300 includes the one or more TRS resource configurations comprise a configuration for a plurality of TRSs having a plurality of scrambling identifications (IDs) configured at a symbol, and the plurality of scrambling IDs are not correlated to each other.

In some aspects, the one or more TRS resource configurations comprise one or more configurations for a time location, a frequency location, a periodicity, quasi co-location (QCL) information, or any combination thereof.

In some aspects, the one or more TRS resource configurations are transmitted as a radio resource control (RRC) message.

In some aspects, the one or more TRS resource configurations further comprise a configuration for one or more scrambling identification (ID) parameters.

In some aspects, the one or more scrambling ID parameters are transmitted as a medium access control-control element (MAC-CE) message or a downlink control information (DCI) message.

In some aspects, the one or more TRS resource configurations comprise a configuration for a plurality of precoded TRS parameters.

In some aspects, the one or more TRS resource configurations comprise a configuration for a plurality of resource block (RB) combs offsets from each other in a time domain and in a frequency domain.

In some aspects, the one or more TRS resource configurations comprise a configuration for a zero cyclic prefix (CP) for one or more of a plurality of TRS symbols.

In some aspects, the one or more TRS resource configurations comprise a configuration for the UE to avoid a sensing measurement, a positioning measurement, or both based on a comparison of a first packet data protocol (PDP) estimated by a TRS and a second PDP estimated by a nearby reference signal (RS) indicating a potential cyclic prefix (CP) attack.

In some aspects, the one or more TRS resource configurations comprise a configuration for a TRS buffering period or a TRS buffering number based on a number of partially processed TRSs capable of being buffered in a storage of the UE.

Although FIG. 13 shows example operations of method 1300, in some implementations, method 1300 may include additional operations, fewer operations, different operations, or differently arranged operations than those depicted in FIG. 13. Additionally, or alternatively, two or more of the operations of method 1300 may be performed in parallel, or performed in a sequence different from the sequence listed in FIG. 13.

As will be appreciated, a technical advantage of the method 1300 is that, by implementing one or more types of TRS resource configurations, including, for example, generating a TRS sequence with distinct and uncorrelated scrambling identifiers (IDs), the described techniques can be used to avoid various types of man-in-the-middle attacks.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:
Clause 1. A method of wireless communication at a user equipment (UE), comprising: receiving, from a network node, one or more tracking reference signal (TRS) resource configurations of a plurality of TRS resource configurations for a plurality of TRS resources, wherein each of the plurality of TRS resource configurations configures one or more TRS resources to avoid one or more security attack types of a plurality of security attack types; and performing one or more sensing operations, one or more positioning operations, or any combination thereof, based on the one or more TRS resource configurations.
Clause 2. The method of clause 1, wherein the plurality of security attack types comprise: a cyclic prefix (CP) attack type; a noise or jamming attack type; a computational attack type; a frequency domain (FD) attack type; a sample-by-sample attack type; a minimum mean square error (MMSE) attack type; a time domain (TD) attack type; or any combination thereof.
Clause 3. The method of any of clauses 1 to 2, wherein the one or more TRS resource configurations comprise a configuration for a TRS sequence generated with a distinct scrambling identification (ID) per symbol.
Clause 4. The method of clause 3, wherein: the distinct scrambling ID is a scrambling ID of a plurality of scrambling IDs; the symbol is a symbol of a plurality of symbols; and the plurality of scrambling IDs are not correlated to the plurality of symbols.
Clause 5. The method of any of clauses 1 to 4, wherein: the one or more TRS resource configurations comprise a configuration for a plurality of TRSs having a plurality of scrambling identifications (IDs) configured at a symbol; and the plurality of scrambling IDs are not correlated to each other.
Clause 6. The method of any of clauses 1 to 5, wherein the one or more TRS resource configurations comprise one or more configurations for: a time location; a frequency location; a periodicity; quasi co-location (QCL) information; one or more scrambling identification (ID) parameters; or any combination thereof.
Clause 7. The method of clause 6, wherein the one or more TRS resource configurations are transmitted as a radio resource control (RRC) message.
Clause 8. The method of any of clauses 6 to 7, wherein the one or more TRS resource configurations further comprise a configuration for one or more scrambling identification (ID) parameters.
Clause 9. The method of clause 8, wherein the one or more scrambling ID parameters are transmitted as a medium access control-control element (MAC-CE) message or a downlink control information (DCI) message.
Clause 10. The method of any of clauses 1 to 9, wherein the one or more TRS resource configurations comprise a configuration for a plurality of precoded TRS parameters.
Clause 11. The method of clause 10, wherein the plurality of precoded TRS parameters are obtained by dividing one or more sub-bands or bandwidth parts (BWPs) into a plurality of physical resource block groups (PRGs) and applying precoding to the plurality of PRGs to obtain the plurality of precoded TRS parameters.
Clause 12. The method of clause 11, wherein the plurality of PRGs comprise at least a first PRG of a first size and a second PRG of a second size different from the first size.
Clause 13. The method of any of clauses 1 to 12, wherein the one or more TRS resource configurations comprise a configuration for a plurality of resource block (RB) combs offset from each other in a time domain and in a frequency domain.
Clause 14. The method of any of clauses 1 to 13, wherein the one or more TRS resource configurations comprise a configuration for a zero cyclic prefix (CP) for one or more of a plurality of TRS symbols.
Clause 15. The method of any of clauses 1 to 14, wherein the one or more TRS resource configurations comprise a configuration for the UE to avoid a sensing measurement, a positioning measurement, or both based on a comparison of a first packet data protocol (PDP) estimated by a TRS and a second PDP estimated by a nearby reference signal (RS) indicating a potential cyclic prefix (CP) attack.
Clause 16. A method of wireless communication at a network node, comprising: determining, for a user equipment (UE), one or more tracking reference signal (TRS) resource configurations of a plurality of TRS resource configurations for a plurality of TRS resources, wherein each of the plurality of TRS resource configurations configures one or more TRS resources to avoid one or more security attack types of a plurality of security attack types; and transmitting, to the UE, the one or more TRS resource configurations.
Clause 17. The method of clause 16, wherein the plurality of security attack types comprise: a cyclic prefix (CP) attack type; a noise or jamming attack type; a computational attack type; a frequency domain (FD) attack type; a sample-by-sample attack type; a minimum mean square error (MMSE) attack type; a time domain (TD) attack type; or any combination thereof.
Clause 18. The method of any of clauses 16 to 17, wherein the one or more TRS resource configurations comprise a configuration for a TRS sequence generated with a distinct scrambling identification (ID) per symbol.
Clause 19. The method of clause 18, wherein: the distinct scrambling ID is a scrambling ID of a plurality of scrambling IDs; the symbol is a symbol of a plurality of symbols; and the plurality of scrambling IDs are not correlated to the plurality of symbols.
Clause 20. The method of any of clauses 16 to 19, wherein: the one or more TRS resource configurations comprise a configuration for a plurality of TRSs having a plurality of scrambling identifications (IDs) configured at a symbol; and the plurality of scrambling IDs are not correlated to each other.
Clause 21. The method of any of clauses 16 to 20, wherein the one or more TRS resource configurations comprise one or more configurations for: a time location; a frequency location; a periodicity; quasi co-location (QCL) information; or any combination thereof.
Clause 22. The method of clause 21, wherein the one or more TRS resource configurations are transmitted as a radio resource control (RRC) message.
Clause 23. The method of any of clauses 21 to 22, wherein the one or more TRS resource configurations further comprise a configuration for one or more scrambling identification (ID) parameters.
Clause 24. The method of clause 23, wherein the one or more scrambling ID parameters are transmitted as a medium access control-control element (MAC-CE) message or a downlink control information (DCI) message.
Clause 25. The method of any of clauses 16 to 24, wherein the one or more TRS resource configurations comprise a configuration for a plurality of precoded TRS parameters.
Clause 26. The method of any of clauses 16 to 25, wherein the one or more TRS resource configurations comprise a configuration for a plurality of resource block (RB) combs offsets from each other in a time domain and in a frequency domain.
Clause 27. The method of any of clauses 16 to 26, wherein the one or more TRS resource configurations comprise a configuration for a zero cyclic prefix (CP) for one or more of a plurality of TRS symbols.
Clause 28. The method of any of clauses 16 to 27, wherein the one or more TRS resource configurations comprise a configuration for the UE to avoid a sensing measurement, a positioning measurement, or both based on a comparison of a first packet data protocol (PDP) estimated by a TRS and a second PDP estimated by a nearby reference signal (RS) indicating a potential cyclic prefix (CP) attack.
Clause 29. A user equipment (UE), comprising: one or more memories; one or more transceivers; and one or more processors communicatively coupled to the one or more memories and the one or more transceivers, the one or more processors, either alone or in combination, configured to: receive, via the one or more transceivers, from a network node, one or more tracking reference signal (TRS) resource configurations of a plurality of TRS resource configurations for a plurality of TRS resources, wherein each of the plurality of TRS resource configurations configures one or more TRS resources to avoid one or more security attack types of a plurality of security attack types; and perform one or more sensing operations, one or more positioning operations, or any combination thereof, based on the one or more TRS resource configurations.
Clause 30. The UE of clause 29, wherein the plurality of security attack types comprise: a cyclic prefix (CP) attack type; a noise or jamming attack type; a computational attack type; a frequency domain (FD) attack type; a sample-by-sample attack type; a minimum mean square error (MMSE) attack type; a time domain (TD) attack type; or any combination thereof.
Clause 31. The UE of any of clauses 29 to 30, wherein the one or more TRS resource configurations comprise a configuration for a TRS sequence generated with a distinct scrambling identification (ID) per symbol.
Clause 32. The UE of clause 31, wherein: the distinct scrambling ID is a scrambling ID of a plurality of scrambling IDs; the symbol is a symbol of a plurality of symbols; and the plurality of scrambling IDs are not correlated to the plurality of symbols.
Clause 33. The UE of any of clauses 29 to 32, wherein: the one or more TRS resource configurations comprise a configuration for a plurality of TRSs having a plurality of scrambling identifications (IDs) configured at a symbol; and the plurality of scrambling IDs are not correlated to each other.
Clause 34. The UE of any of clauses 29 to 33, wherein the one or more TRS resource configurations comprise one or more configurations for: a time location; a frequency location; a periodicity; quasi co-location (QCL) information; one or more scrambling identification (ID) parameters; or any combination thereof.
Clause 35. The UE of clause 34, wherein the one or more TRS resource configurations are transmitted as a radio resource control (RRC) message.
Clause 36. The UE of any of clauses 34 to 35, wherein the one or more TRS resource configurations further comprise a configuration for one or more scrambling identification (ID) parameters.
Clause 37. The UE of clause 36, wherein the one or more scrambling ID parameters are transmitted as a medium access control-control element (MAC-CE) message or a downlink control information (DCI) message.
Clause 38. The UE of any of clauses 29 to 37, wherein the one or more TRS resource configurations comprise a configuration for a plurality of precoded TRS parameters.
Clause 39. The UE of clause 38, wherein the plurality of precoded TRS parameters are obtained by dividing one or more sub-bands or bandwidth parts (BWPs) into a plurality of physical resource block groups (PRGs) and applying precoding to the plurality of PRGs to obtain the plurality of precoded TRS parameters.
Clause 40. The UE of clause 39, wherein the plurality of PRGs comprise at least a first PRG of a first size and a second PRG of a second size different from the first size.
Clause 41. The UE of any of clauses 29 to 40, wherein the one or more TRS resource configurations comprise a configuration for a plurality of resource block (RB) combs offset from each other in a time domain and in a frequency domain.
Clause 42. The UE of any of clauses 29 to 41, wherein the one or more TRS resource configurations comprise a configuration for a zero cyclic prefix (CP) for one or more of a plurality of TRS symbols.
Clause 43. The UE of any of clauses 29 to 42, wherein the one or more TRS resource configurations comprise a configuration for the UE to avoid a sensing measurement, a positioning measurement, or both based on a comparison of a first packet data protocol (PDP) estimated by a TRS and a second PDP estimated by a nearby reference signal (RS) indicating a potential cyclic prefix (CP) attack.
Clause 44. A network node, comprising: one or more memories; one or more transceivers; and one or more processors communicatively coupled to the one or more memories and the one or more transceivers, the one or more processors, either alone or in combination, configured to: determine, for a user equipment (UE), one or more tracking reference signal (TRS) resource configurations of a plurality of TRS resource configurations for a plurality of TRS resources, wherein each of the plurality of TRS resource configurations configures one or more TRS resources to avoid one or more security attack types of a plurality of security attack types; and transmit, via the one or more transceivers, to the UE, the one or more TRS resource configurations.
Clause 45. The network node of clause 44, wherein the plurality of security attack types comprise: a cyclic prefix (CP) attack type; a noise or jamming attack type; a computational attack type; a frequency domain (FD) attack type; a sample-by-sample attack type; a minimum mean square error (MMSE) attack type; a time domain (TD) attack type; or any combination thereof.
Clause 46. The network node of any of clauses 44 to 45, wherein the one or more TRS resource configurations comprise a configuration for a TRS sequence generated with a distinct scrambling identification (ID) per symbol.
Clause 47. The network node of clause 46, wherein: the distinct scrambling ID is a scrambling ID of a plurality of scrambling IDs; the symbol is a symbol of a plurality of symbols; and the plurality of scrambling IDs are not correlated to the plurality of symbols.
Clause 48. The network node of any of clauses 44 to 47, wherein: the one or more TRS resource configurations comprise a configuration for a plurality of TRSs having a plurality of scrambling identifications (IDs) configured at a symbol; and the plurality of scrambling IDs are not correlated to each other.
Clause 49. The network node of any of clauses 44 to 48, wherein the one or more TRS resource configurations comprise one or more configurations for: a time location; a frequency location; a periodicity; quasi co-location (QCL) information; or any combination thereof.
Clause 50. The network node of clause 49, wherein the one or more TRS resource configurations are transmitted as a radio resource control (RRC) message.
Clause 51. The network node of any of clauses 49 to 50, wherein the one or more TRS resource configurations further comprise a configuration for one or more scrambling identification (ID) parameters.
Clause 52. The network node of clause 51, wherein the one or more scrambling ID parameters are transmitted as a medium access control-control element (MAC-CE) message or a downlink control information (DCI) message.
Clause 53. The network node of any of clauses 44 to 52, wherein the one or more TRS resource configurations comprise a configuration for a plurality of precoded TRS parameters.
Clause 54. The network node of any of clauses 44 to 53, wherein the one or more TRS resource configurations comprise a configuration for a plurality of resource block (RB) combs offsets from each other in a time domain and in a frequency domain.
Clause 55. The network node of any of clauses 44 to 54, wherein the one or more TRS resource configurations comprise a configuration for a zero cyclic prefix (CP) for one or more of a plurality of TRS symbols.
Clause 56. The network node of any of clauses 44 to 55, wherein the one or more TRS resource configurations comprise a configuration for the UE to avoid a sensing measurement, a positioning measurement, or both based on a comparison of a first packet data protocol (PDP) estimated by a TRS and a second PDP estimated by a nearby reference signal (RS) indicating a potential cyclic prefix (CP) attack.
Clause 57. A user equipment (UE), comprising: means for receiving, from a network node, one or more tracking reference signal (TRS) resource configurations of a plurality of TRS resource configurations for a plurality of TRS resources, wherein each of the plurality of TRS resource configurations configures one or more TRS resources to avoid one or more security attack types of a plurality of security attack types; and means for performing one or more sensing operations, one or more positioning operations, or any combination thereof, based on the one or more TRS resource configurations.
Clause 58. The UE of clause 57, wherein the plurality of security attack types comprise: a cyclic prefix (CP) attack type; a noise or jamming attack type; a computational attack type; a frequency domain (FD) attack type; a sample-by-sample attack type; a minimum mean square error (MMSE) attack type; a time domain (TD) attack type; or any combination thereof.
Clause 59. The UE of any of clauses 57 to 58, wherein the one or more TRS resource configurations comprise a configuration for a TRS sequence generated with a distinct scrambling identification (ID) per symbol.
Clause 60. The UE of clause 59, wherein: the distinct scrambling ID is a scrambling ID of a plurality of scrambling IDs; the symbol is a symbol of a plurality of symbols; and the plurality of scrambling IDs are not correlated to the plurality of symbols.
Clause 61. The UE of any of clauses 57 to 60, wherein: the one or more TRS resource configurations comprise a configuration for a plurality of TRSs having a plurality of scrambling identifications (IDs) configured at a symbol; and the plurality of scrambling IDs are not correlated to each other.
Clause 62. The UE of any of clauses 57 to 61, wherein the one or more TRS resource configurations comprise one or more configurations for: a time location; a frequency location; a periodicity; quasi co-location (QCL) information; one or more scrambling identification (ID) parameters; or any combination thereof.
Clause 63. The UE of clause 62, wherein the one or more TRS resource configurations are transmitted as a radio resource control (RRC) message.
Clause 64. The UE of any of clauses 62 to 63, wherein the one or more TRS resource configurations further comprise a configuration for one or more scrambling identification (ID) parameters.
Clause 65. The UE of clause 64, wherein the one or more scrambling ID parameters are transmitted as a medium access control-control element (MAC-CE) message or a downlink control information (DCI) message.
Clause 66. The UE of any of clauses 57 to 65, wherein the one or more TRS resource configurations comprise a configuration for a plurality of precoded TRS parameters.
Clause 67. The UE of clause 66, wherein the plurality of precoded TRS parameters are obtained by dividing one or more sub-bands or bandwidth parts (BWPs) into a plurality of physical resource block groups (PRGs) and applying precoding to the plurality of PRGs to obtain the plurality of precoded TRS parameters.
Clause 68. The UE of clause 67, wherein the plurality of PRGs comprise at least a first PRG of a first size and a second PRG of a second size different from the first size.
Clause 69. The UE of any of clauses 57 to 68, wherein the one or more TRS resource configurations comprise a configuration for a plurality of resource block (RB) combs offset from each other in a time domain and in a frequency domain.
Clause 70. The UE of any of clauses 57 to 69, wherein the one or more TRS resource configurations comprise a configuration for a zero cyclic prefix (CP) for one or more of a plurality of TRS symbols.
Clause 71. The UE of any of clauses 57 to 70, wherein the one or more TRS resource configurations comprise a configuration for the UE to avoid a sensing measurement, a positioning measurement, or both based on a comparison of a first packet data protocol (PDP) estimated by a TRS and a second PDP estimated by a nearby reference signal (RS) indicating a potential cyclic prefix (CP) attack.
Clause 72. A network node, comprising: means for determining, for a user equipment (UE), one or more tracking reference signal (TRS) resource configurations of a plurality of TRS resource configurations for a plurality of TRS resources, wherein each of the plurality of TRS resource configurations configures one or more TRS resources to avoid one or more security attack types of a plurality of security attack types; and means for transmitting, to the UE, the one or more TRS resource configurations.
Clause 73. The network node of clause 72, wherein the plurality of security attack types comprise: a cyclic prefix (CP) attack type; a noise or jamming attack type; a computational attack type; a frequency domain (FD) attack type; a sample-by-sample attack type; a minimum mean square error (MMSE) attack type; a time domain (TD) attack type; or any combination thereof.
Clause 74. The network node of any of clauses 72 to 73, wherein the one or more TRS resource configurations comprise a configuration for a TRS sequence generated with a distinct scrambling identification (ID) per symbol.
Clause 75. The network node of clause 74, wherein: the distinct scrambling ID is a scrambling ID of a plurality of scrambling IDs; the symbol is a symbol of a plurality of symbols; and the plurality of scrambling IDs are not correlated to the plurality of symbols.
Clause 76. The network node of any of clauses 72 to 75, wherein: the one or more TRS resource configurations comprise a configuration for a plurality of TRSs having a plurality of scrambling identifications (IDs) configured at a symbol; and the plurality of scrambling IDs are not correlated to each other.
Clause 77. The network node of any of clauses 72 to 76, wherein the one or more TRS resource configurations comprise one or more configurations for: a time location; a frequency location; a periodicity; quasi co-location (QCL) information; or any combination thereof.
Clause 78. The network node of clause 77, wherein the one or more TRS resource configurations are transmitted as a radio resource control (RRC) message.
Clause 79. The network node of any of clauses 77 to 78, wherein the one or more TRS resource configurations further comprise a configuration for one or more scrambling identification (ID) parameters.
Clause 80. The network node of clause 79, wherein the one or more scrambling ID parameters are transmitted as a medium access control-control element (MAC-CE) message or a downlink control information (DCI) message.
Clause 81. The network node of any of clauses 72 to 80, wherein the one or more TRS resource configurations comprise a configuration for a plurality of precoded TRS parameters.
Clause 82. The network node of any of clauses 72 to 81, wherein the one or more TRS resource configurations comprise a configuration for a plurality of resource block (RB) combs offsets from each other in a time domain and in a frequency domain.
Clause 83. The network node of any of clauses 72 to 82, wherein the one or more TRS resource configurations comprise a configuration for a zero cyclic prefix (CP) for one or more of a plurality of TRS symbols.
Clause 84. The network node of any of clauses 72 to 83, wherein the one or more TRS resource configurations comprise a configuration for the UE to avoid a sensing measurement, a positioning measurement, or both based on a comparison of a first packet data protocol (PDP) estimated by a TRS and a second PDP estimated by a nearby reference signal (RS) indicating a potential cyclic prefix (CP) attack.
Clause 85. A non-transitory computer-readable medium stores computer-executable instructions that, when executed by a user equipment (UE), cause the UE to: receive, from a network node, one or more tracking reference signal (TRS) resource configurations of a plurality of TRS resource configurations for a plurality of TRS resources, wherein each of the plurality of TRS resource configurations configures one or more TRS resources to avoid one or more security attack types of a plurality of security attack types; and perform one or more sensing operations, one or more positioning operations, or any combination thereof, based on the one or more TRS resource configurations.
Clause 86. The non-transitory computer-readable medium of clause 85, wherein the plurality of security attack types comprise: a cyclic prefix (CP) attack type; a noise or jamming attack type; a computational attack type; a frequency domain (FD) attack type; a sample-by-sample attack type; a minimum mean square error (MMSE) attack type; a time domain (TD) attack type; or any combination thereof.
Clause 87. The non-transitory computer-readable medium of any of clauses 85 to 86, wherein the one or more TRS resource configurations comprise a configuration for a TRS sequence generated with a distinct scrambling identification (ID) per symbol.
Clause 88. The non-transitory computer-readable medium of clause 87, wherein: the distinct scrambling ID is a scrambling ID of a plurality of scrambling IDs; the symbol is a symbol of a plurality of symbols; and the plurality of scrambling IDs are not correlated to the plurality of symbols.
Clause 89. The non-transitory computer-readable medium of any of clauses 85 to 88, wherein: the one or more TRS resource configurations comprise a configuration for a plurality of TRSs having a plurality of scrambling identifications (IDs) configured at a symbol; and the plurality of scrambling IDs are not correlated to each other.
Clause 90. The non-transitory computer-readable medium of any of clauses 85 to 89, wherein the one or more TRS resource configurations comprise one or more configurations for: a time location; a frequency location; a periodicity; quasi co-location (QCL) information; one or more scrambling identification (ID) parameters; or any combination thereof.
Clause 91. The non-transitory computer-readable medium of clause 90, wherein the one or more TRS resource configurations are transmitted as a radio resource control (RRC) message.
Clause 92. The non-transitory computer-readable medium of any of clauses 90 to 91, wherein the one or more TRS resource configurations further comprise a configuration for one or more scrambling identification (ID) parameters.
Clause 93. The non-transitory computer-readable medium of clause 92, wherein the one or more scrambling ID parameters are transmitted as a medium access control-control element (MAC-CE) message or a downlink control information (DCI) message.
Clause 94. The non-transitory computer-readable medium of any of clauses 85 to 93, wherein the one or more TRS resource configurations comprise a configuration for a plurality of precoded TRS parameters.
Clause 95. The non-transitory computer-readable medium of clause 94, wherein the plurality of precoded TRS parameters are obtained by dividing one or more sub-bands or bandwidth parts (BWPs) into a plurality of physical resource block groups (PRGs) and applying precoding to the plurality of PRGs to obtain the plurality of precoded TRS parameters.
Clause 96. The non-transitory computer-readable medium of clause 95, wherein the plurality of PRGs comprise at least a first PRG of a first size and a second PRG of a second size different from the first size.
Clause 97. The non-transitory computer-readable medium of any of clauses 85 to 96, wherein the one or more TRS resource configurations comprise a configuration for a plurality of resource block (RB) combs offset from each other in a time domain and in a frequency domain.
Clause 98. The non-transitory computer-readable medium of any of clauses 85 to 97, wherein the one or more TRS resource configurations comprise a configuration for a zero cyclic prefix (CP) for one or more of a plurality of TRS symbols.
Clause 99. The non-transitory computer-readable medium of any of clauses 85 to 98, wherein the one or more TRS resource configurations comprise a configuration for the UE to avoid a sensing measurement, a positioning measurement, or both based on a comparison of a first packet data protocol (PDP) estimated by a TRS and a second PDP estimated by a nearby reference signal (RS) indicating a potential cyclic prefix (CP) attack.
Clause 100. A non-transitory computer-readable medium stores computer-executable instructions that, when executed by a network node, cause the network node to: determine, for a user equipment (UE), one or more tracking reference signal (TRS) resource configurations of a plurality of TRS resource configurations for a plurality of TRS resources, wherein each of the plurality of TRS resource configurations configures one or more TRS resources to avoid one or more security attack types of a plurality of security attack types; and transmit, to the UE, the one or more TRS resource configurations.
Clause 101. The non-transitory computer-readable medium of clause 100, wherein the plurality of security attack types comprise: a cyclic prefix (CP) attack type; a noise or jamming attack type; a computational attack type; a frequency domain (FD) attack type; a sample-by-sample attack type; a minimum mean square error (MMSE) attack type; a time domain (TD) attack type; or any combination thereof.
Clause 102. The non-transitory computer-readable medium of any of clauses 100 to 101, wherein the one or more TRS resource configurations comprise a configuration for a TRS sequence generated with a distinct scrambling identification (ID) per symbol.
Clause 103. The non-transitory computer-readable medium of clause 102, wherein: the distinct scrambling ID is a scrambling ID of a plurality of scrambling IDs; the symbol is a symbol of a plurality of symbols; and the plurality of scrambling IDs are not correlated to the plurality of symbols.
Clause 104. The non-transitory computer-readable medium of any of clauses 100 to 103, wherein: the one or more TRS resource configurations comprise a configuration for a plurality of TRSs having a plurality of scrambling identifications (IDs) configured at a symbol; and the plurality of scrambling IDs are not correlated to each other.
Clause 105. The non-transitory computer-readable medium of any of clauses 100 to 104, wherein the one or more TRS resource configurations comprise one or more configurations for: a time location; a frequency location; a periodicity; quasi co-location (QCL) information; or any combination thereof.
Clause 106. The non-transitory computer-readable medium of clause 105, wherein the one or more TRS resource configurations are transmitted as a radio resource control (RRC) message.
Clause 107. The non-transitory computer-readable medium of any of clauses 105 to 106, wherein the one or more TRS resource configurations further comprise a configuration for one or more scrambling identification (ID) parameters.
Clause 108. The non-transitory computer-readable medium of clause 107, wherein the one or more scrambling ID parameters are transmitted as a medium access control-control element (MAC-CE) message or a downlink control information (DCI) message.
Clause 109. The non-transitory computer-readable medium of any of clauses 100 to 108, wherein the one or more TRS resource configurations comprise a configuration for a plurality of precoded TRS parameters.
Clause 110. The non-transitory computer-readable medium of any of clauses 100 to 109, wherein the one or more TRS resource configurations comprise a configuration for a plurality of resource block (RB) combs offsets from each other in a time domain and in a frequency domain.
Clause 111. The non-transitory computer-readable medium of any of clauses 100 to 110, wherein the one or more TRS resource configurations comprise a configuration for a zero cyclic prefix (CP) for one or more of a plurality of TRS symbols.
Clause 112. The non-transitory computer-readable medium of any of clauses 100 to 111, wherein the one or more TRS resource configurations comprise a configuration for the UE to avoid a sensing measurement, a positioning measurement, or both based on a comparison of a first packet data protocol (PDP) estimated by a TRS and a second PDP estimated by a nearby reference signal (RS) indicating a potential cyclic prefix (CP) attack.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an ASIC, a field-programable gate array (FPGA), or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. For example, the functions, steps and/or actions of the method claims in accordance with the aspects of the disclosure described herein need not be performed in any particular order. Further, no component, function, action, or instruction described or claimed herein should be construed as critical or essential unless explicitly described as such. Furthermore, as used herein, the terms “set,” “group,” and the like are intended to include one or more of the stated elements. Also, as used herein, the terms “has,” “have,” “having,” “comprises,” “comprising,” “includes,” “including,” and the like does not preclude the presence of one or more additional elements (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”) or the alternatives are mutually exclusive (e.g., “one or more” should not be interpreted as “one and more”). Furthermore, although components, functions, actions, and instructions may be described or claimed in the singular, the plural is contemplated unless limitation to the singular is explicitly stated. Accordingly, as used herein, the articles “a,” “an,” “the,” and “said” are intended to include one or more of the stated elements. Additionally, as used herein, the terms “at least one” and “one or more” encompass “one” component, function, action, or instruction performing or capable of performing a described or claimed functionality and also “two or more” components, functions, actions, or instructions performing or capable of performing a described or claimed functionality in combination.

What is claimed is:

1. A user equipment (UE), comprising:
one or more memories;
one or more transceivers; and
one or more processors communicatively coupled to the one or more memories and the one or more transceivers, the one or more processors, either alone or in combination, configured to:
receive, via the one or more transceivers, from a network node, one or more tracking reference signal (TRS) resource configurations of a plurality of TRS resource configurations for a plurality of TRS resources, wherein each of the plurality of TRS resource configurations configures one or more TRS resources to avoid one or more security attack types of a plurality of security attack types; and
perform one or more sensing operations, one or more positioning operations, or any combination thereof, based on the one or more TRS resource configurations.

2. The UE of claim 1, wherein the plurality of security attack types comprise:
a cyclic prefix (CP) attack type;
a noise or jamming attack type;
a computational attack type;
a frequency domain (FD) attack type;
a sample-by-sample attack type;
a minimum mean square error (MMSE) attack type;
a time domain (TD) attack type;
or any combination thereof.

3. The UE of claim 1, wherein the one or more TRS resource configurations comprise a configuration for a TRS sequence generated with a distinct scrambling identification (ID) per symbol.

4. The UE of claim 3, wherein:
the distinct scrambling ID is a scrambling ID of a plurality of scrambling IDs;
the symbol is a symbol of a plurality of symbols; and
the plurality of scrambling IDs are not correlated to the plurality of symbols.

5. The UE of claim 1, wherein:
the one or more TRS resource configurations comprise a configuration for a plurality of TRSs having a plurality of scrambling identifications (IDs) configured at a symbol; and
the plurality of scrambling IDs are not correlated to each other.

6. The UE of claim 1, wherein the one or more TRS resource configurations comprise one or more configurations for:
a time location;
a frequency location;
a periodicity;
quasi co-location (QCL) information;
one or more scrambling identification (ID) parameters;
or any combination thereof.

7. The UE of claim 6, wherein the one or more TRS resource configurations are transmitted as a radio resource control (RRC) message.

8. The UE of claim 6, wherein the one or more TRS resource configurations further comprise a configuration for one or more scrambling identification (ID) parameters.

9. The UE of claim 8, wherein the one or more scrambling ID parameters are transmitted as a medium access control-control element (MAC-CE) message or a downlink control information (DCI) message.

10. The UE of claim 1, wherein the one or more TRS resource configurations comprise a configuration for a plurality of precoded TRS parameters.

11. The UE of claim 10, wherein the plurality of precoded TRS parameters are obtained by dividing one or more sub-bands or bandwidth parts (BWPs) into a plurality of physical resource block groups (PRGs) and applying precoding to the plurality of PRGs to obtain the plurality of precoded TRS parameters.

12. The UE of claim 11, wherein the plurality of PRGs comprise at least a first PRG of a first size and a second PRG of a second size different from the first size.

13. The UE of claim 1, wherein the one or more TRS resource configurations comprise a configuration for a plurality of resource block (RB) combs offset from each other in a time domain and in a frequency domain.

14. The UE of claim 1, wherein the one or more TRS resource configurations comprise a configuration for a zero cyclic prefix (CP) for one or more of a plurality of TRS symbols.

15. The UE of claim 1, wherein the one or more TRS resource configurations comprise a configuration for the UE to avoid a sensing measurement, a positioning measurement, or both based on a comparison of a first packet data protocol (PDP) estimated by a TRS and a second PDP estimated by a nearby reference signal (RS) indicating a potential cyclic prefix (CP) attack.

16. A network node, comprising:
one or more memories;
one or more transceivers; and
one or more processors communicatively coupled to the one or more memories and the one or more transceivers, the one or more processors, either alone or in combination, configured to:
determine, for a user equipment (UE), one or more tracking reference signal (TRS) resource configurations of a plurality of TRS resource configurations for a plurality of TRS resources, wherein each of the plurality of TRS resource configurations configures one or more TRS resources to avoid one or more security attack types of a plurality of security attack types; and
transmit, via the one or more transceivers, to the UE, the one or more TRS resource configurations.

17. The network node of claim 16, wherein the plurality of security attack types comprise:
a cyclic prefix (CP) attack type;
a noise or jamming attack type;
a computational attack type;
a frequency domain (FD) attack type;
a sample-by-sample attack type;
a minimum mean square error (MMSE) attack type;
a time domain (TD) attack type;
or any combination thereof.

18. The network node of claim 16, wherein the one or more TRS resource configurations comprise a configuration for a TRS sequence generated with a distinct scrambling identification (ID) per symbol.

19. The network node of claim 18, wherein:
the distinct scrambling ID is a scrambling ID of a plurality of scrambling IDs;
the symbol is a symbol of a plurality of symbols; and
the plurality of scrambling IDs are not correlated to the plurality of symbols.

20. The network node of claim 16, wherein:
the one or more TRS resource configurations comprise a configuration for a plurality of TRSs having a plurality of scrambling identifications (IDs) configured at a symbol; and
the plurality of scrambling IDs are not correlated to each other.

21. The network node of claim 16, wherein the one or more TRS resource configurations comprise one or more configurations for:
a time location;
a frequency location;
a periodicity;
quasi co-location (QCL) information;
or any combination thereof.

22. The network node of claim 21, wherein the one or more TRS resource configurations are transmitted as a radio resource control (RRC) message.

23. The network node of claim 21, wherein the one or more TRS resource configurations further comprise a configuration for one or more scrambling identification (ID) parameters.

24. The network node of claim 23, wherein the one or more scrambling ID parameters are transmitted as a medium access control-control element (MAC-CE) message or a downlink control information (DCI) message.

25. The network node of claim 16, wherein the one or more TRS resource configurations comprise a configuration for a plurality of precoded TRS parameters.

26. The network node of claim 16, wherein the one or more TRS resource configurations comprise a configuration for a plurality of resource block (RB) combs offsets from each other in a time domain and in a frequency domain.

27. The network node of claim 16, wherein the one or more TRS resource configurations comprise a configuration for a zero cyclic prefix (CP) for one or more of a plurality of TRS symbols.

28. The network node of claim 16, wherein the one or more TRS resource configurations comprise a configuration for the UE to avoid a sensing measurement, a positioning measurement, or both based on a comparison of a first packet data protocol (PDP) estimated by a TRS and a second PDP estimated by a nearby reference signal (RS) indicating a potential cyclic prefix (CP) attack.

29. A method of wireless communication at a user equipment (UE), comprising:
receiving, from a network node, one or more tracking reference signal (TRS) resource configurations of a plurality of TRS resource configurations for a plurality of TRS resources, wherein each of the plurality of TRS resource configurations configures one or more TRS resources to avoid one or more security attack types of a plurality of security attack types; and
performing one or more sensing operations, one or more positioning operations, or any combination thereof, based on the one or more TRS resource configurations.

30. A method of wireless communication at a network node, comprising:
determining, for a user equipment (UE), one or more tracking reference signal (TRS) resource configurations of a plurality of TRS resource configurations for a plurality of TRS resources, wherein each of the plurality of TRS resource configurations configures one or more TRS resources to avoid one or more security attack types of a plurality of security attack types; and
transmitting, to the UE, the one or more TRS resource configurations.
